(19) United States
(12) Patent Application Publication
(10) Pub. No.: US 2014/0189482 A1
(43) Pub. Date: Jul. 3, 2014

(54) METHOD FOR MANIPULATING TABLES ON AN INTERACTIVE INPUT SYSTEM AND INTERACTIVE INPUT SYSTEM EXECUTING THE METHOD

(71) Applicant: SMART Technologies ULC, Calgary (CA)

(72) Inventor: Doug B. Hill, Calgary (CA)

(73) Assignee: SMART Technologies ULC, Calgary (CA)

(21) Appl. No.: 14/140,949

(22) Filed: Dec. 26, 2013

Related U.S. Application Data
(60) Provisional application No. 61/747,508, filed on Dec. 31, 2012.

(51) Int. Cl. G06F 17/24

(52) U.S. Cl. CPC G06F 17/241; G06F 17/245; G06F 17/246
USPC 715/212; 715/227

(57) ABSTRACT

A method is provide for manipulating a table comprising a plurality of cells, at least one row header and at least one column header. Input events representing a pointer contacting an interactive surface are received. An ink annotation is displayed on the interactive surface in response to the input events. It is determined that the ink annotation corresponds with an ink gesture by comparing the ink annotation with a plurality of predefined ink gestures. The ink annotation is deleted and one or more commands associated with the ink gesture are executed. A system configured to implement the method and a computer readable medium storing instructions to implement the method are also provided.

This application claims priority from U.S. Provisional Patent Application No. 61/747,508 filed Dec. 31, 2012.

### FIELD OF THE INVENTION

The present invention relates generally to interactive input systems, and in particular to a method for manipulating tables on an interactive input system and an interactive input system employing the same.

### BACKGROUND OF THE INVENTION

Interactive input systems that allow users to inject input such as for example digital ink, mouse events etc. into an application program using an active pointer (e.g. a pointer that emits light, sound or other signal), a passive pointer (e.g., a finger, cylinder or other object) or other suitable input device such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 and in U.S. Patent Application Publication No. 2004/0179001, all assigned to SMART Technologies ULC of Calgary, Alberta, Canada, assignee of the subject application, the entire disclosures of which are incorporated herein by reference; touch systems comprising touch panels employing electromagnetic, capacitive, acoustic or other technologies to register pointer input; tablet and laptop personal computers (PCs); smartphones, personal digital assistants (PDAs) and other handheld devices; and other similar devices. Sometimes, interactive input systems also comprise other input devices such as for example computer mouse, keyboard, trackball, etc.

Applications running on interactive input systems usually present a graphic user interface (GUI), in the form of a window for example, comprising one or more graphic objects for user to manipulate using one or more input devices. For example, a spreadsheet application, such as Microsoft Excel®, Apache OpenOffice Calc, Lotus Symphony Spreadsheets or Corel Quattro Pro, presents in the GUI a table comprising cells organized in rows and columns. A user may use an input device, e.g., a computer mouse, a keyboard, or a pointer, to manipulate the table and content therein. Other, non-spreadsheet application, such as Microsoft Word, Apache OpenOffice Writer, Corel WordPerfect or SMART Notebook, for example, allows a user to insert a table into a document, and manipulate the table using an input device.

As is known, gestures may be used on interactive devices to manipulate the GUI. Gestures comprise a series of input events injected by an input device, such as a touch input device, according to a predefined pattern. For example, it is well known that applying two pointers on an interactive surface over a displayed graphical object (such as an image for example) and moving the two pointers apart from each other is a gesture to zoom-in on the graphical object. However, it is still difficult to manipulate tables using touch input devices.

U.S. Pat. No. 5,848,187 describes a method for entering and manipulating spreadsheet cell data. It provides a method for determining the target cell for written information and for scaling the information to fit within the boundaries of the target cell. A multi-tiered character recognition scheme is used to improve the accuracy and speed of character recognition and translation of handwritten data. The original handwritten data is preserved so that either the translated data or original data may be displayed. The invention also provides for improved editing of cell entries by allowing a plurality of editing tools to be selected. Manipulation of blocks of data can be accomplished with simple gestures. Arithmetic, statistical and logical functions can be invoked with a single command. It also discloses a double-tapping gesture such that double-tapping a cell automatically selects all contiguous cells from the first cell to the next “boundary” in the direction of the second tap. A double tap may be horizontal (selecting a row of cells), vertical (selecting a column of cells), or diagonal (selecting a two-dimensional block of cells).

U.S. Patent Application No. 2012/0180002 discloses different gestures and actions for interacting with spreadsheets. The gestures are used in manipulating the spreadsheet and performing other actions in the spreadsheet. For example, gestures may be used to move within the spreadsheet, select data, filter, sort, drill down/up, zoom, split rows/columns, perform undo/redo actions, and the like. Sensors that are associated with a device may also be used in interacting with spreadsheets. For example, an accelerometer may be used for moving and performing operations within the spreadsheet.

U.S. Patent Application No. 2011/0163968 discloses an electronic device having a display and a touch-sensitive surface displaying a table having a plurality of rows, a plurality of columns, and a plurality of cells. The device detects a gesture on the touch-sensitive surface that includes movement of one or more of a first contact and a second contact. When the detected gesture is a pinch gesture at a location that corresponds to one or more respective columns in the table and has a component that is perpendicular to the one or more respective columns, the device decreases the width of the one or more respective columns. When the detected gesture is a de-pinch gesture at a location that corresponds to one or more respective columns in the table and has a component that is perpendicular to the one or more respective columns, the device increases the width of the one or more respective columns.

U.S. Patent Application No. 2012/0013539 discloses computing equipment such as devices with touch screen displays and other touch sensitive equipment for displaying tables of data to a user. The tables of data may contain rows and columns. Touch gestures such as tap and flick gestures may be detected using the touch screen or other touch sensor. In response to a detected tap such as a tap on a row or column header, the computing equipment may select and highlight a corresponding row or column in a displayed table. In response to a flick gesture in a particular direction, the computing equipment may move the selected row or column to a new position within the table. For example, if the user selects a particular column and supplies a right flick gestures, the selected column may be moved to the right edge of a body region in the table.

U.S. Patent Application No. 2012/0013540 discloses computing equipment displaying tables of data that contain rows and columns. Touch gestures such as hold and flick gestures may be detected using a touch screen or other touch sensor. In response to a detected hold portion of a hold and flick gesture, a row or column in a table may be selected. In response to detection of a simultaneous flick portion, columns or rows may be inserted or deleted. A column may be inserted after a selected column using a hold and right downflick gesture. A hold and left downflick gesture may be used to insert a column before a selected column. Rows may be inserted before and after selected rows using hold and upper rightflick and hold and lower rightflick gestures. One or more columns or rows may be deleted using upflick or leftflick gestures.

While the gestures described are useful, there still lacks an intuitive method for manipulating tables including spreadsheets using gestures. Accordingly, improvements are desired. It is therefore an object to provide a novel method for manipulating tables and a novel interactive input system employing the same.

### SUMMARY OF THE INVENTION

In accordance with an aspect of the present invention there is provided a computerized method for manipulating a table comprising a plurality of cells, at least one row header and at least one column header, the method comprising: receiving input events representing a pointer contacting an interactive surface; displaying an ink annotation on the interactive surface in response to the input events; determining that the ink annotation corresponds with an ink gesture by comparing the ink annotation with a plurality of predefined ink gestures; and deleting the ink annotation and executing one or more commands associated with the ink gesture.

In accordance with another aspect of the present invention there is provided a system configured to manipulating a table comprising a plurality of cells, at least one row header and at least one column header, the system comprising: an interactive display configured to display content and receive user input; a computer having memory for storing instructions, which when executed by a processor cause the computer to: receive input events representing a pointer contacting an interactive surface; display an ink annotation on the interactive surface in response to the input events; determine that the ink annotation corresponds with an ink gesture by comparing the ink annotation with a plurality of predefined ink gestures; and delete the ink annotation and executing one or more commands associated with the ink gesture.

In accordance with another aspect of the present invention there is provided a computer readable medium having stored thereon instructions for manipulating a table comprising a plurality of cells, at least one row header and at least one column header, the instructions, when executed by a processor, cause the processor to implement: receiving input events representing a pointer contacting an interactive surface; displaying an ink annotation on the interactive surface in response to the input events; determining that the ink annotation corresponds with an ink gesture by comparing the ink annotation with a plurality of predefined ink gestures; and deleting the ink annotation and executing one or more commands associated with the ink gesture.

In one embodiment, the comparing the ink annotation with a plurality of predefined ink gestures comprises categorizing the ink annotation based on a location at which the ink annotation began, comparing the categorized ink annotation with category-specific criteria, and associating the ink annotation with a corresponding one of the plurality of predefined ink gestures based on the comparison.

### BRIEF DESCRIPTION OF THE DRAWINGS

Embodiments will now be described by way of example only with reference to the accompanying drawings in which:

FIG. 1 is a perspective view of an interactive input system;

FIG. 2 is a simplified block diagram of the software architecture of the interactive input system of FIG. 1;

FIG. 3 illustrates a portion of a spreadsheet displayed on an interactive surface of the interactive input system of FIG. 1;

FIGS. 4A and 4B show a flowchart showing exemplary steps performed by the application program for detecting ink gestures;

FIGS. 5A to 5C show an example of recognizing an ink annotation as a merge-cell gesture for merging cells in the same column;

FIGS. 6A to 6C show another example of recognizing an ink annotation as a merge-cell gesture for merging cells in the same column;

FIGS. 7A to 7C show an example of recognizing an ink annotation as a merge-cell gesture for merging cells in the same row;

FIGS. 8A to 8C show an example of recognizing an ink annotation as a split-cell gesture for splitting a cell to two cells in the same row;

FIGS. 9A to 9C show an example of recognizing an ink annotation as a split-cell gesture for splitting a cell to two cells in the same column;

FIGS. 10A to 10C show an example of recognizing an ink annotation as a clear-cell-content gesture;

FIGS. 11A to 11C show an example of recognizing an ink annotation as a delete-row gesture;

FIGS. 12A to 12C show an example of recognizing an ink annotation as a delete-column gesture;

FIGS. 13A to 13C show an example of recognizing an ink annotation as an insert-row gesture;

FIGS. 14A to 14C show an example of recognizing an ink annotation as an insert-column gesture;

FIGS. 15A to 15D show an example of recognizing an ink annotation as an insert-column gesture according to an alternative embodiment;

FIGS. 16A to 16C show an example of recognizing an ink annotation as a delete-row gesture according to yet an alternative embodiment;

FIGS. 17A to 17D show an example of recognizing an ink annotation as a delete-row gesture according to still an alternative embodiment;

FIGS. 18A to 18C show an example of capturing a portion of table by using an ink gesture according to another embodiment;

FIG. 19 shows an example of capturing a portion of table by using an ink gesture according to yet another embodiment; and

FIGS. 20A to 20C show an example of recognizing an ink annotation as a define-cell-range gesture according to still another embodiment.

### DETAILED DESCRIPTION OF THE EMBODIMENTS

Interactive input systems and methods for manipulating tables are now described. In the following description, a table refers to a graphic presentation comprising a plurality of cells organized in rows and columns, where each cell is capable of containing content such as text, images, digital ink annotation, shapes, and other suitable objects, for example. As skilled persons in the art would appreciate, tables may take various forms in various embodiments. For example, in some embodiments, a table may be a spreadsheet processed in a spreadsheet program such as Microsoft® Excel, for example. In another embodiment, a table may be a table in a word processing file processed in a word processing program, such as Microsoft® Word, for example. In yet another embodiment, a table may be a table in a presentation slide processed in a presentation program, such as SMART Notebook™, for example. Other types of tables may exist in other suitable files processed by respective application programs. Further, sometimes a table may refer to a user-defined subset of cells. For example, in Microsoft® Excel, a user may define a range of cells in a spreadsheet as a table.

A table may be a regular table in which each row or column comprises the same number of cells. Alternatively, a table may be an irregular table in which not all rows or columns comprise the same number of cells. A table may comprise row headers and/or column headers. In some embodiments, the row headers and/or the column headers are automatically defined by the application program and attached to the table. In some other embodiments, the row headers and/or column headers are defined by users.

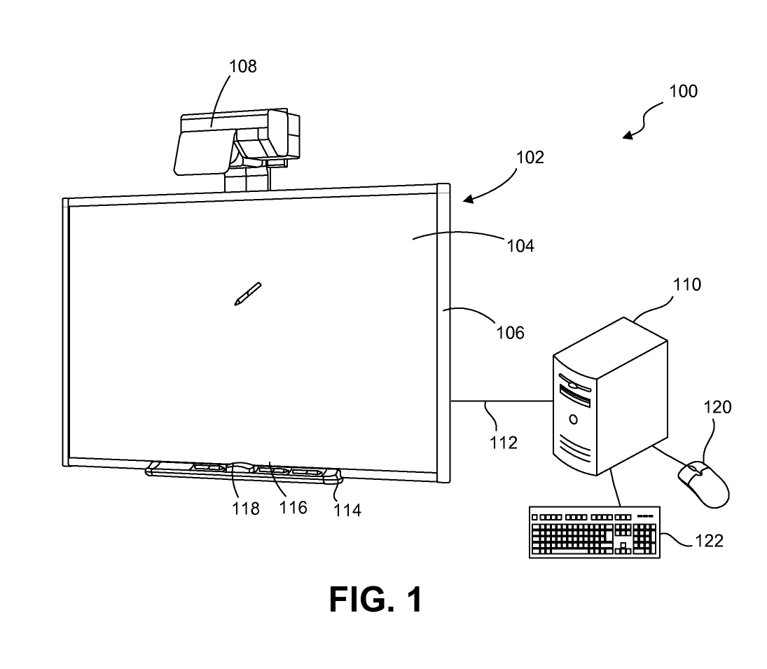

Referring to FIG. 1, an interactive input system is shown is generally identified by reference numeral 100. The interactive input system 100 allows one or more users to inject input such as digital ink, mouse events, commands, and the like into an executing application program. In this embodiment, the interactive input system 100 comprises an interactive device 102, a projector 108, and a general purpose computing device 110

In this embodiment, the interactive device 102 is a two-dimensional (2D) interactive device in the form of an interactive whiteboard (IWB). The IWB 102 is mounted on a vertical support such as a wall surface, a frame structure or the like. The IWB 102 comprises a generally planar, rectangular interactive surface 104 that is surrounded about its periphery by a bezel 106.

A tool tray 114 is affixed to the IWB 102 adjacent the bottom bezel segment using suitable fasteners such as screws, clips, adhesive or the like. As can be seen, the tool tray 114 comprises a housing having an upper surface configured to define a plurality of receptacles or slots. The receptacles are sized to receive one or more pen tools 116 as well as an eraser tool 118 that can be used to interact with the interactive surface 104. Control buttons (not shown) are also provided on the upper surface of the tool tray 114 to enable a user to control operation of the interactive input system 100. Further specifics of the tool tray 114 are described in U.S. Patent Application Publication No. 2011/0169736 to Bolt et al., filed on Feb. 19, 2010, and entitled “INTERACTIVE INPUT SYSTEM AND TOOL TRAY THEREFOR”, the disclosure of which is incorporated herein by reference in its entirety.

In this embodiment, the projector 108 is an ultra-short-throw projector such as that sold by SMART Technologies ULC of Calgary, Alberta, Canada, assignee of the subject application, under the name “SMART UX60”. The projector 108 is mounted on the support surface above the IWB 102 and projects an image, such as a computer desktop for example, onto the interactive surface 104.

The bezel 106 is mechanically fastened to the interactive surface 104 and comprises four bezel segments that extend along the edges of the interactive surface 104. In this embodiment, the inwardly facing surface of each bezel segment comprises a single, longitudinally extending strip or band of retro-reflective material. To take best advantage of the properties of the retro-reflective material, the bezel segments are oriented so that their inwardly facing surfaces lie in a plane generally normal to the plane of the interactive surface 104.

Imaging assemblies (not shown) are accommodated by the bezel 106, with each imaging assembly being positioned adjacent a different corner of the bezel. Each of the imaging assemblies comprises an image sensor and associated lens assembly that provides the image sensor with a field of view sufficiently large as to encompass the entire interactive surface 104. A digital signal processor (DSP) or other suitable processing device sends clock signals to the image sensor causing the image sensor to capture image frames at the desired frame rate. During image frame capture, the DSP also causes an infrared (IR) light source to illuminate and flood the region of interest over the interactive surface 104 with IR illumination. Thus, when no pointer exists within the field of view of the image sensor, the image sensor sees the illumination reflected by the retro-reflective bands on the bezel segments and captures image frames comprising a continuous bright band. When a pointer exists within the field of view of the image sensor, the pointer occludes reflected IR illumination and appears as a dark region interrupting the bright band in captured image frames.

The imaging assemblies are oriented so that their fields of view overlap and look generally across the entire interactive surface 104. In this manner, any pointer such as for example a user's finger, a cylinder or other suitable object, the pen tool 116 or the eraser tool 118 lifted from a receptacle of the tool tray 114, that is brought into proximity of the interactive surface 104 appears in the fields of view of the imaging assemblies and thus, is captured in image frames acquired by multiple imaging assemblies. When the imaging assemblies acquire image frames in which a pointer exists, the imaging assemblies convey pointer data to the general purpose computing device 110.

As described above, the IWB 102 employs machine vision to detect one or more pointers brought into a region of interest in proximity with the interactive surface 104. The IWB 102 communicates with a general purpose computing device 110 executing one or more application programs via a universal serial bus (USB) cable 112 or other suitable wired or wireless communication link. General purpose computing device 110 processes the output of the IWB 102 and adjusts image data that is output to the projector 108, if required, so that the image presented on the interactive surface 104 reflects pointer activity. In this manner, the IWB 102, general purpose computing device 110 and projector 108 allow pointer activity proximate to the interactive surface 104 to be recorded as writing or drawing or used to control execution of one or more application programs executed by the general purpose computing device 110.

In this embodiment, the general purpose computing device 110 is a personal computer or other suitable processing device comprising, for example, a processing unit, system memory (volatile and/or non-volatile memory), other non-removable or removable memory (e.g., a hard disk drive, RAM, ROM, EEPROM, CD-ROM, DVD, flash memory, etc.) and a system bus coupling the various computer components to the processing unit. The general purpose computing device 110 may also comprise networking capabilities using Ethernet, WiFi, and/or other suitable network format, to enable connection to shared or remote drives, one or more networked computers, or other networked devices. A mouse 120 and a keyboard 122 are coupled to the general purpose computing device 110.

The general purpose computing device 110 processes pointer data received from the imaging assemblies to resolve pointer ambiguity by combining the pointer data detected by the imaging assemblies, and computing the locations of pointers proximate the interactive surface 104 (sometimes referred as “pointer contacts”) using well known triangulation. The computed pointer locations are then recorded as writing or drawing or used as an input command to control execution of an application program as described above.

In addition to computing the locations of pointers proximate to the interactive surface 104, the general purpose computing device 110 also determines the pointer types (for example, pen tool 116, finger or palm) by using pointer type data received from the IWB 102. Here, the pointer type data is generated for each pointer contact by at least one of the imaging assembly DSPs by differentiating a curve of growth derived from a horizontal intensity profile of pixels corresponding to each pointer tip in captured image frames. Specifics of methods used to determine pointer type are disclosed in U.S. Pat. No. 7,532,206 to Morrison, et al., and assigned to SMART Technologies ULC, the disclosure of which is incorporated herein by reference in its entirety.

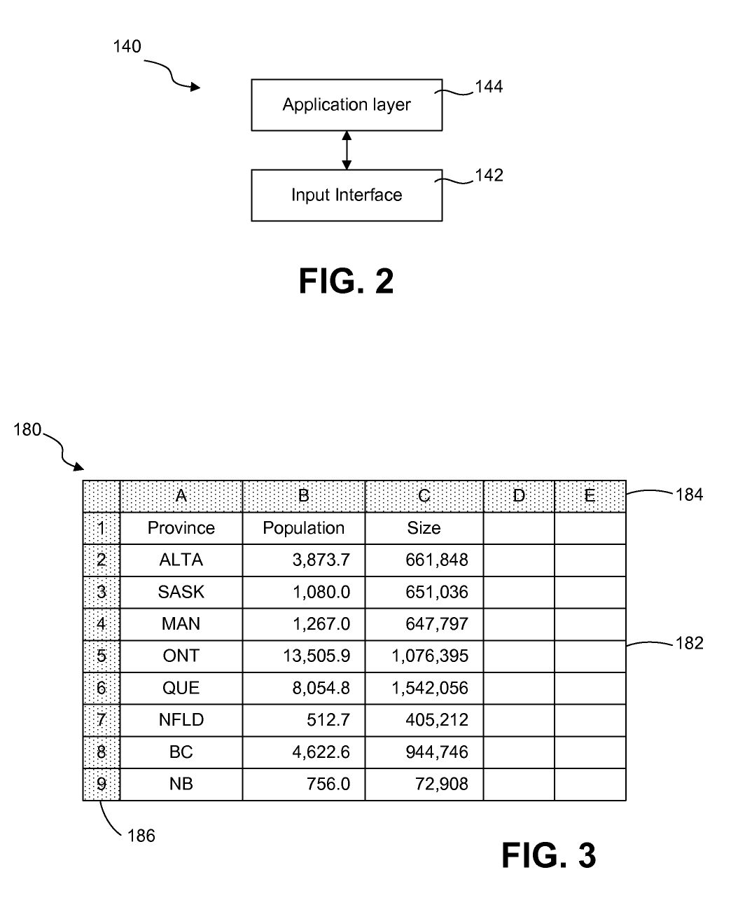

Referring to FIG. 2, an exemplary software architecture used by the interactive input system 100 is generally identified by reference numeral 140. The software architecture 140 comprises an input interface 142, and an application program layer 144 comprising one or more application programs. The input interface 142 is configured to receive input from various input sources generated from the input devices of the interactive input system 100. In this embodiment, the input devices include the IWB 102, the mouse 120, and the keyboard 122. The input interface 142 processes received input and generates input events. The generated input events are then transmitted to the application program layer 144 for processing.

As one or more pointers contact the interactive surface 104 of the IWB 102, associated input events are generated. The input events are generated from the time the one or more pointers are brought into contact with the interactive surface 104 (referred to as a contact down event) until the time the one or more pointers are lifted from the interactive surface 104 (referred to as a contact up event). As will be appreciated, a contact down event is similar to a mouse down event in a typical graphical user interface utilizing mouse input, wherein a user presses the left mouse button. Similarly, a contact up event is similar to a mouse up event in a typical graphical user interface utilizing mouse input, wherein a user releases the pressed mouse button. A contact move event is generated when a pointer is contacting and moving on the interactive surface 104, and is similar to a mouse drag event in a typical graphical user interface utilizing mouse input, wherein a user moves the mouse while pressing and holding the left mouse button.

Users may interact with the interactive input system 100 via the IWB 102, the mouse 120 and/or the keyboard 122 to perform a number of operations such as injecting digital ink or text and manipulating graphical objects, for example. In the event a user contacts the IWB 102 with a pointer, the mode of the pointer is determined as being either in the cursor mode or the ink mode. The interactive input system 100 assigns each pointer a default mode. For example, a finger in contact with the interactive surface 104 is assigned by default the cursor mode while the pen tool 116 in contact with the interactive surface 104 is assigned by default the ink mode.

A user may configure a pointer to the cursor mode or the ink mode. This can be achieved, for example, by pressing a respective mode button on the tool tray 114, by tapping a respective mode button presented in a GUI presented on the IWB 102, or by pressing a respective mode button on the pointer (if such a button exists). When a pointer is configured to the cursor mode, it may be used to inject commands to the application program. Examples of commands include selecting a graphic object, pressing a software button, and the like. When a pointer is configured to the ink mode, it may be used to inject digital ink into the GUI. Examples of digital ink include a handwritten annotation, a line, a shape, and the like.

In this embodiment, the application program layer 144 includes a spreadsheet program. As is well known, a spreadsheet program presents, in a GUI, a table comprising cells organized in rows and columns. Referring to FIG. 3 a portion of a spreadsheet displayed on an interactive surface 104 of the interactive input system 100 is illustrated by numeral 180. For ease of illustration, some well-known GUI elements, such as title bar, menu bar, toolbar, spreadsheet tabs, and the like are not shown in FIG. 3. Input events applied to these non-illustrated GUI elements are processed in a well-known manner, so they are not described herein.

The spreadsheet 180 comprises cells 182 organized in rows and columns. The spreadsheet 180 also comprises column headers 184, each corresponding to a column of cells 182, and row headers 186 each corresponding to a row of cells 182. In this example, the row headers 186 and column headers 184 are automatically generated by the spreadsheet program. Usually, the row headers 186 are labeled using consecutive numerals, and column headers 184 are labeled using consecutive letters. Users may select a cell 182 and input or edit its content. For example, a user may configure a pointer to the cursor mode, and tap the pointer on a cell 182 to select it. The user may alternatively configure a pointer to the ink mode and inject digital ink into the cell 182. The user may further command the execution of a handwriting recognition program or program module to recognize the digital ink, convert it to text, and inject the converted text into a user-designated cell. A user may also use the keyboard 122 or a software keyboard on the GUI to inject text into the cells 182.

Software executing at the application program layer 144 processes input events received from the input interface 142 to recognize gestures based on the movement of one or more pointers in contact with the interactive surface 104. The software is configured to interface between the input interface 142 and the application programs executing in the application program layer 144. The software may be configured as part of the application program layer 144, as a separate module within the application program layer 144, or as part of application programs within the application program layer 144. In this embodiment, the software is configured as part of the application program layer 144.

An ink gesture is an input event that corresponds with a set of predefined rules and is identified based on a number of criteria, as will be described in greater detail. In this embodiment, the application program layer 144 is configured to recognize ink gestures when the pointer is configured in the ink mode. That is, the application program layer 144 receives a user-injected ink annotation, and determines if the ink annotation corresponds with an ink gesture. If the ink annotation corresponds with an ink gesture, a corresponding series of actions can be applied to the spreadsheet application.

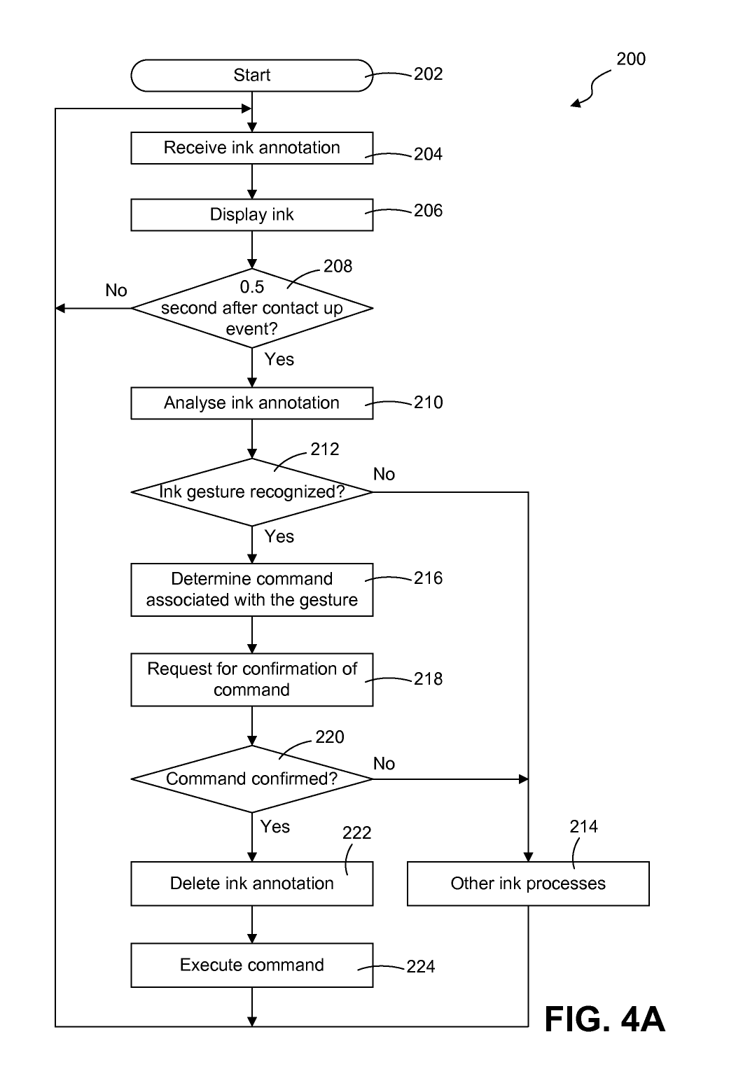

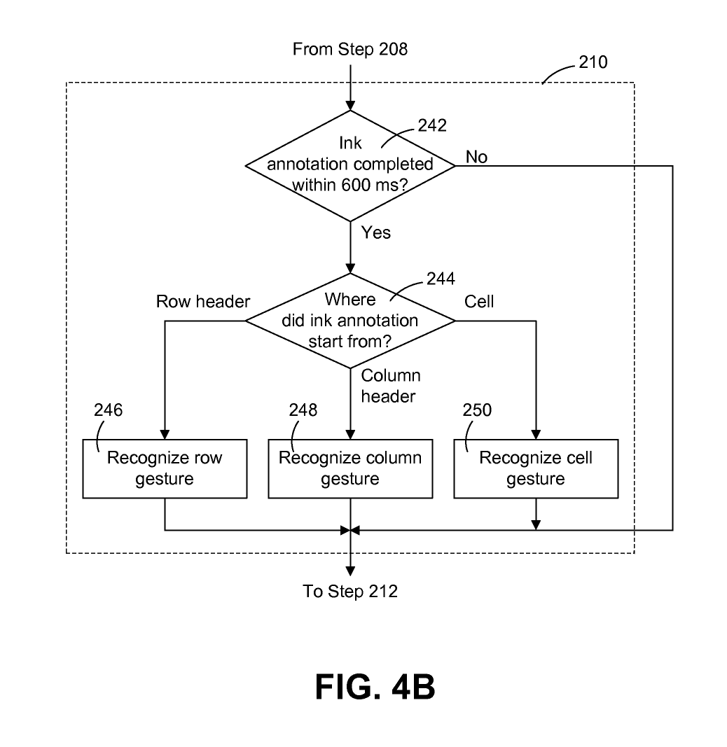

Referring to FIG. 4A, a flowchart illustrating exemplary steps performed by the application program layer 144 for detecting ink gestures is shown generally by numeral 200. The process starts at step 202, when a user uses a pointer in ink mode to contact the interactive surface 104. Specifically, the user uses the pointer to inject ink onto the interactive surface 104 over the GUI representing the spreadsheet 180 of the spreadsheet program. Accordingly, pointer contacts are injected into the application program layer 144 as ink annotation. At step 204, the application program layer 144 receives the ink annotation and, at step 206, displays the ink annotation on the interactive surface 104.

At step 208, the application program layer 144 monitors the ink annotation to determine when it is complete. In this embodiment, the ink annotation is determined to be complete when the pointer injecting the ink annotation has been lifted from the interactive surface for at least a predefined annotation time threshold T₁. That is, once a contact up event is triggered, if more time than the annotation time threshold T₁ passes before a contact down event from the same pointer is triggered, the ink annotation is determined to be complete. An example of the annotation time threshold T₁ is 0.5 seconds, although it may vary depending on the implementation.

In this embodiment, the same pointer is determined to be in contact again with the interactive surface if a contact down event from a pen tool 116 of the same type occurs. However, those skilled in the art will appreciate that other methods for determining that the same pointer is again in contact with the interactive surface 104 may also be used. For example, in some embodiments where the IWB 102 does not output the pointer type information, a contact down event generated proximate an end point of the ink annotation within a predefined time threshold T₃ is considered as the same pointer being again in contact with the interactive surface. In another embodiment, the IWB 102 is able to detect the identity (ID) of each pointer and the application program layer 144 determines that the same pointer is again in contact with the interactive surface only when a contact down event from a pen tool 116 having the same ID occurs.

While the ink annotation is incomplete, the application program layer returns to step 204 and further ink annotations are received and displayed, at step 206, on the interactive surface 104. When the ink annotation is complete, the application program layer 144 continues to step 210.

At step 210, the application program layer 144 analyses the ink annotation by comparing it with a plurality of predefined ink gestures. Examples of predefined ink gestures will be described throughout the various embodiments described herein. At step 212, it is determined if the ink annotation corresponds with one of the plurality of ink gestures. If the ink annotation does not correspond with one of the plurality of ink gestures then the application program layer 144 continues at step 214 and performs other ink processes, if applicable. Examples of other ink processes include grouping the injected ink annotation with other ink annotations, recognizing injected ink annotation as text, recognizing injected ink annotation as a shape, smoothing the injected ink annotation, rendering the injected ink annotation as calligraphic ink, and the like. The application program layer 144 then returns to step 204 to receive the next ink annotation.

If, at step 212, it is determined that the ink annotation corresponds with one of the plurality of ink gestures, then the application program layer 144 continues at step 216. At step 216, the application program layer 144 determines the command associated with the recognized ink gesture. At step 218, the user is asked to confirm that the command associated with the recognized ink gesture is the command to be executed. At step 220, it is determined whether or not the user confirmed the command. If the user rejected the command, then the application program layer continues at step 214. If the user confirmed the command, then at step 222, the ink annotation is deleted. At step 224, the command associated with the ink gesture, and confirmed by the user, is executed. The application program layer 144 then returns to step 204 to receive another ink annotation.

Referring to FIG. 4b, a flowchart illustrating exemplary steps performed during analyses of the ink annotation is shown. At step 242, it is determined if the ink annotation was completed within a predetermined brief period of time T₂. In this embodiment, ink annotations are configured to be implemented relatively quickly as compared to other ink processes such as entering text or drawing objects, for example. Accordingly, an example of the brief period of time T₂ is 600 milliseconds, although it may vary depending on the implementation.

If the time taken to complete the ink annotation was greater than the brief period of time T₂, the ink annotation is not considered to represent an ink gesture and the application program layer 144 continues at step 212 shown in FIG. 4A.

If the time taken to complete the ink annotation was less than the brief period of time T₂, the ink annotation is considered to represent an ink gesture and the application program 144 continues to step 244. At step 244, the application program layer 144 determines a category of ink gesture with which the ink annotation is associated. Specifically, in this embodiment, the ink gestures are categorized as row gestures, column gestures or cell gestures, based on a location at which the ink annotation began. A row gesture is an ink gesture associated with a command that, when executed, impacts an entire row. A column gesture is an ink gesture associated with a command that, when executed, impacts an entire column. A cell gesture is an ink gesture associated with a command that, when executed, only impacts one or more selected cells. Accordingly, at step 244 it is determined whether the ink annotation began at a location associated with a row header 186, a column header 184, or a cell 182.

If, at step 244, the ink annotation began at a location associated with a row header 186, the application program 144 continues at step 246. At step 246, it is determined if the ink annotation satisfies other row gesture criteria defined for a row gesture. The application program layer 144 determines that the ink annotation represents a row gesture if the ink annotation satisfies the other row gesture criteria, and that the ink annotation does not represent a row gesture if the ink annotation does not satisfy other row gesture criteria. The application program layer continues at step 212 shown in FIG. 4A.

If, at step 244, the ink annotation began at a location associated with a column header 184, the application program 144 continues at step 248. At step 248, it is determined if the ink annotation satisfies other column gesture criteria defined for a column gesture. Examples of such criteria include, for example, length, shape, direction, and the like. The application program layer 144 determines that the ink annotation represents a column gesture if the ink annotation satisfies the other column gesture criteria, and that the ink annotation does not represent a column gesture if the ink annotation does not satisfy other column gesture criteria. The application program layer continues at step 212 shown in FIG. 4A.

If, at step 244, the ink annotation began at a location associated with a cell 182, the application program 144 continues at step 248. At step 248, it is determined if the ink annotation satisfies other cell gesture criteria defined for a cell gesture. The application program layer 144 determines that the ink annotation represents a cell gesture if the ink annotation satisfies the other cell gesture criteria, and that the ink annotation does not represent a cell gesture if the ink annotation does not satisfy other cell gesture criteria. The application program layer continues at step 212 shown in FIG. 4A.

For example, if the application program layer 144 determines that the ink annotation, which started at a location associate with a row header 186 and is completed within the brief time period T₂, horizontally traverses the row header 186, has a length between two-thirds and three (3) times of the width of the row header 186, and is substantially in a straight line, the application program layer 144 determines that the ink annotation represents an insert-row gesture.

As another example, if the application program layer 144 determines that the ink annotation, which started at a location associate with a column header 184 and is completed within the brief time period T₂, vertically traverses the column header 184, has a length between two-thirds and three (3) times of the height of the column header 184, and is substantially in a straight line, the application program layer 144 determines that the ink annotation represents an insert-column gesture.

As yet another example, if the application program 144 determines that the ink annotation, which started at a location associate with a first cell C₁ of the spreadsheet and is completed within the brief time period T₂, extends from the first cell C₁ to a second cell C₂, and is substantially in a straight line or arced shape, the application program layer 144 determines that the ink annotation represents a merge-cell gesture.

Thus it will be appreciated that, in the present embodiment, the application program layer recognizes a potential ink annotation as an ink gesture based on whether the ink annotation is completed within the brief period of time T₂. The application program layer 144 categorizes the ink annotations into one of a row gesture, column gesture or a cell gesture based on the location at which the ink annotation began. The ink annotation is then compared with other criteria for categorized gestures. In this way, the application program layer 144 can differentiate an ink gesture from an actual ink annotation. The application program layer 144 also allows users to apply different commands by using similar gestures. For example, if a user quickly applies an ink annotation from and horizontally traversing a row header 186, the application program layer 144 recognizes the ink annotation as an insert-row gesture. However, if a user quickly applies an ink annotation from a first cell and horizontally extends the ink annotation to a second cell, the application program layer 144 recognizes the ink annotation as a merge-cell gesture.

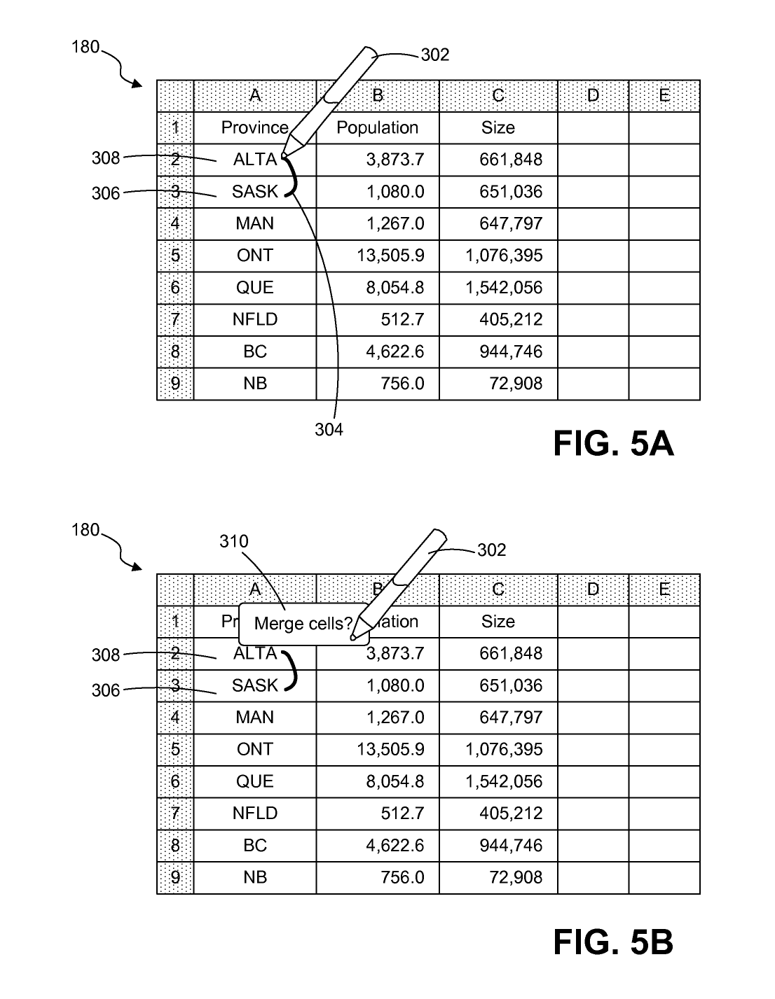

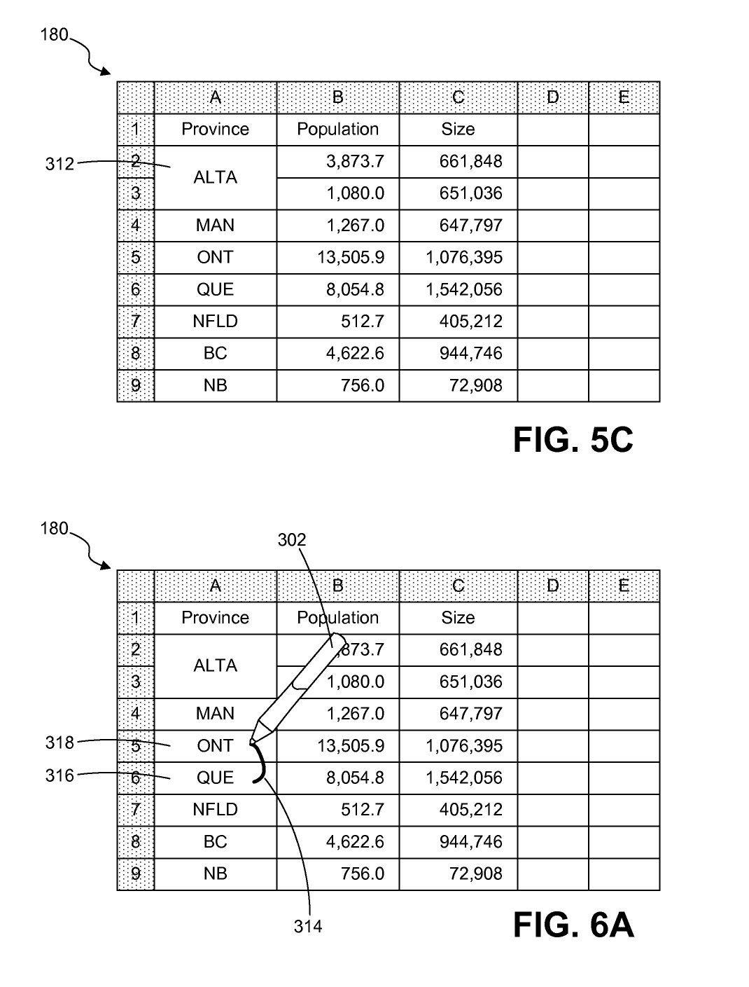

In the following, examples are described to further exemplify the ink gesture recognition described above. Referring to FIGS. 5A to 5C, an example of recognizing an ink annotation as a merge-cell gesture for merging cells is shown. FIG. 5A shows a portion of a spreadsheet 180. A user (not shown) uses a pen tool 302 in the ink mode to draw an ink annotation 304 from a first cell 306 to a second cell 308 in the same column. Following the steps in FIGS. 4A and 4B, the spreadsheet program receives the ink annotation 304 (step 204) and displays the received ink annotation 304 on the interactive surface (step 206). When the user lifts the pen tool 302, the spreadsheet program starts a timer and monitors if the same pointer is again in contact with the interactive surface within the annotation time threshold T₁ (step 208).

As shown in FIG. 5B, the application program layer 144 determines that the pen tool 302 did not contact the interactive surface within the predetermined time threshold T₁. Therefore, the application program layer 144 starts to analyse whether the ink annotation 304 represents an ink gesture (step 210). Since the ink annotation 304 is completed within the brief time period T₂ (step 242), and started from a cell (step 244), the application program layer 144 determines that the ink annotation 304 possibly represents a cell gesture. Accordingly, the other cell gesture criteria are checked (step 250). Since the ink annotation 304 overlaps with two (2) cells 306 and 308, and is substantially in an arc shape, a merge-cell gesture is determined. Consequently, the merge-cell command associated with the merge-cell gesture is determined (step 216), and the application program layer 144 presents a pop-up bubble 310 to ask the user to confirm the gesture corresponds with the command to be executed (step 218). The user may tap the bubble 310 using the pen tool 302 or finger (not shown) to confirm the gesture (step 220). Alternatively, the user may tap the bubble 310 using the pen tool 302 or finger (not shown) to decline the command (step 220), depending on the configuration.

As shown in FIG. 5C, after the user confirms the command to be executed, the application program layer 144 deletes the ink annotation 304 (step 222), and executes the merge-cell command (step 224). As a result, the cells 306 and 308 are merged to a single cell 312.

For ease of description, for all of the following examples, it is assumed that all ink annotations are completed within the brief time period T₂ and meet the required other criteria of their corresponding categories.

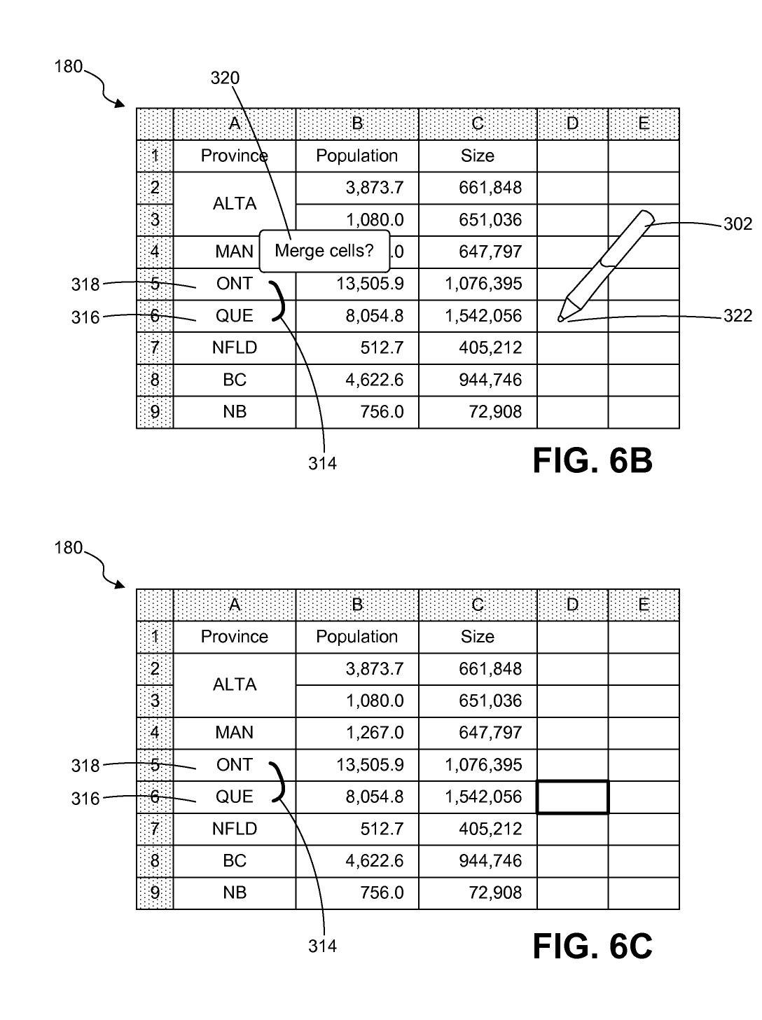

Referring to FIGS. 6A to 6C another example of recognizing an ink annotation as a merge-cell gesture is shown. As shown in FIG. 6A, a user (not shown) uses a pen tool 302 in the ink mode to draw an ink annotation 314 from a first cell 316 to a second cell 318 in the same column. Similar to the description above, the application program layer 144 recognizes the ink annotation 314 as a merge-cell gesture, and presents up a pop-up bubble 320 asking the user to confirm the merge-cell gesture, as shown in FIG. 6B. However, in this example, the user rejects the merge-cell gesture. As a result, cells 316 and 318 are not merged, and the ink annotation 314 is maintained, as shown in FIG. 6C.

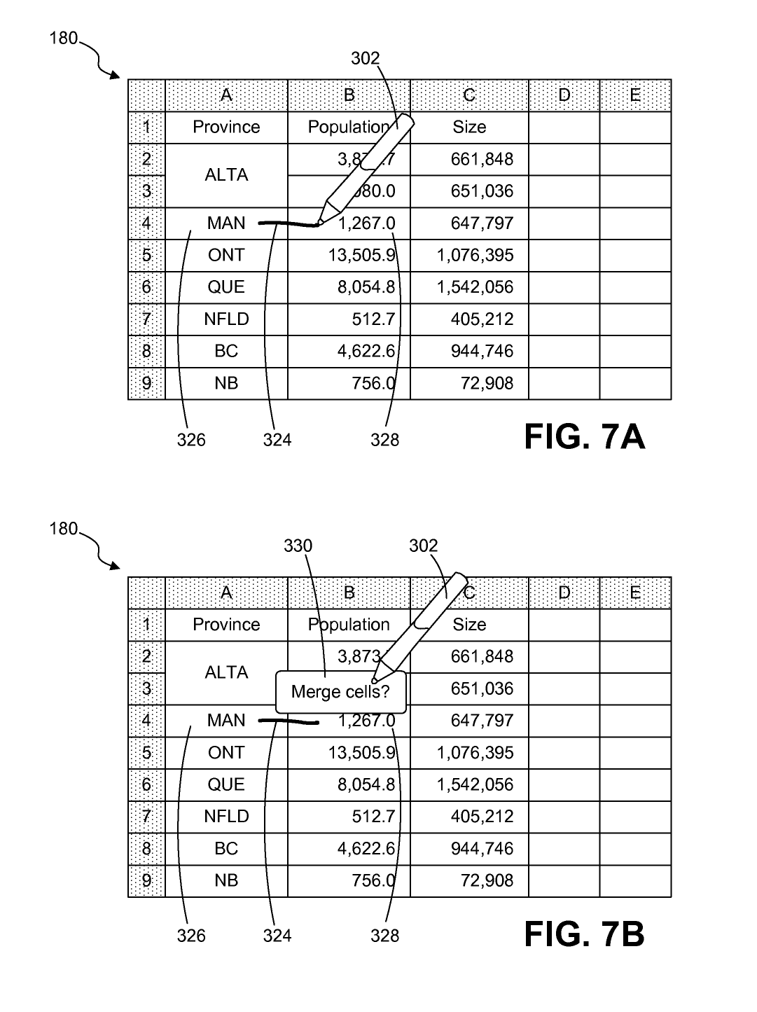

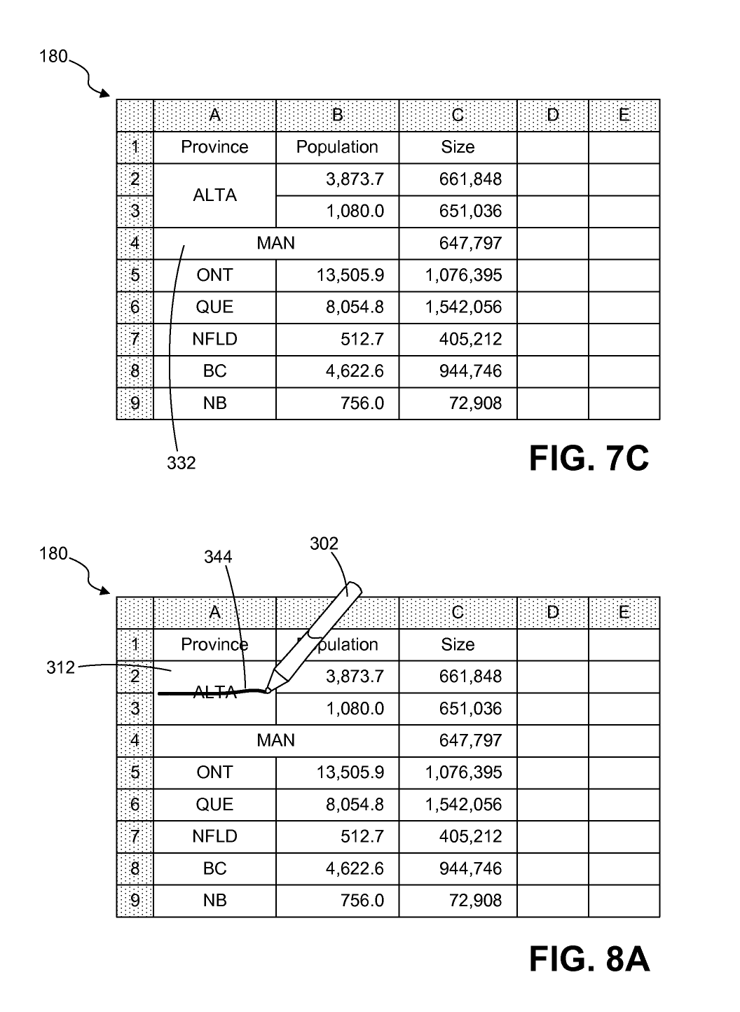

The merge-cell gesture may also be used for merging cells in the same row. Referring to FIGS. 7A to 7C an example of merging cells in the same row is shown. As shown in FIG. 7A, a user (not shown) uses a pen tool 302 in the ink mode to draw an ink annotation 324 from a first cell 326 to a second cell 328 in the same row. As shown in FIG. 7B, after the ink annotation 324 is complete, the application program layer 144 recognizes the ink annotation 324 as a merge-cell gesture, and presents a pop-up bubble 330 asking the user to confirm the merge-cell gesture. The user confirms the merge-cell gesture. As shown in FIG. 7C, the application program layer 144 deletes the ink annotation 324, and executes the merge-cell command. As a result, the cells 326 and 328 are merged to a single cell 332.

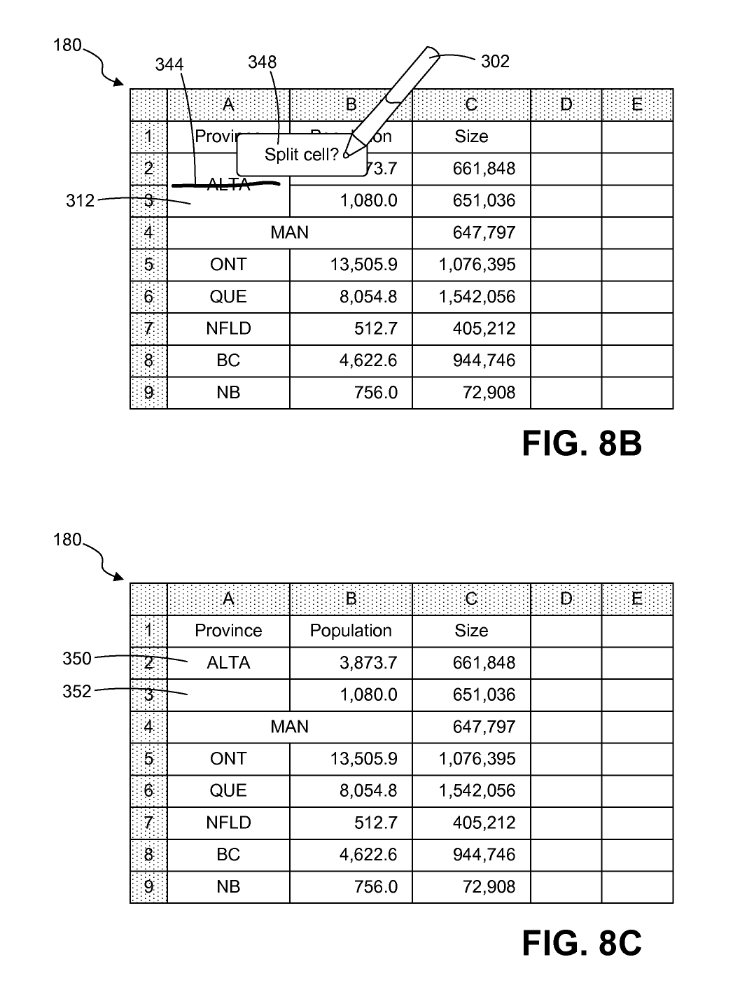

Referring to FIGS. 8A to 8C, an example of recognizing an ink annotation as a split-cell gesture for splitting a cell to two cells in the same column is shown. As shown in FIG. 8A, a user (not shown) uses a pen tool 302 in the ink mode to draw a horizontal ink annotation 344 having a substantially straight line in cell 312. As shown in FIG. 8B, after the ink annotation 344 is complete, the application program layer 144 recognizes the ink annotation 344 as a split-cell gesture, and presents a pop-up bubble 348 asking the user to confirm the command associated with the recognized gesture. The user confirms the split-cell gesture. As shown in FIG. 8C, the ink annotation 344 is then deleted, and the command associated with the split-cell gesture is executed. As a result, cell 312 is split to two cells 350 and 352 in the same column.

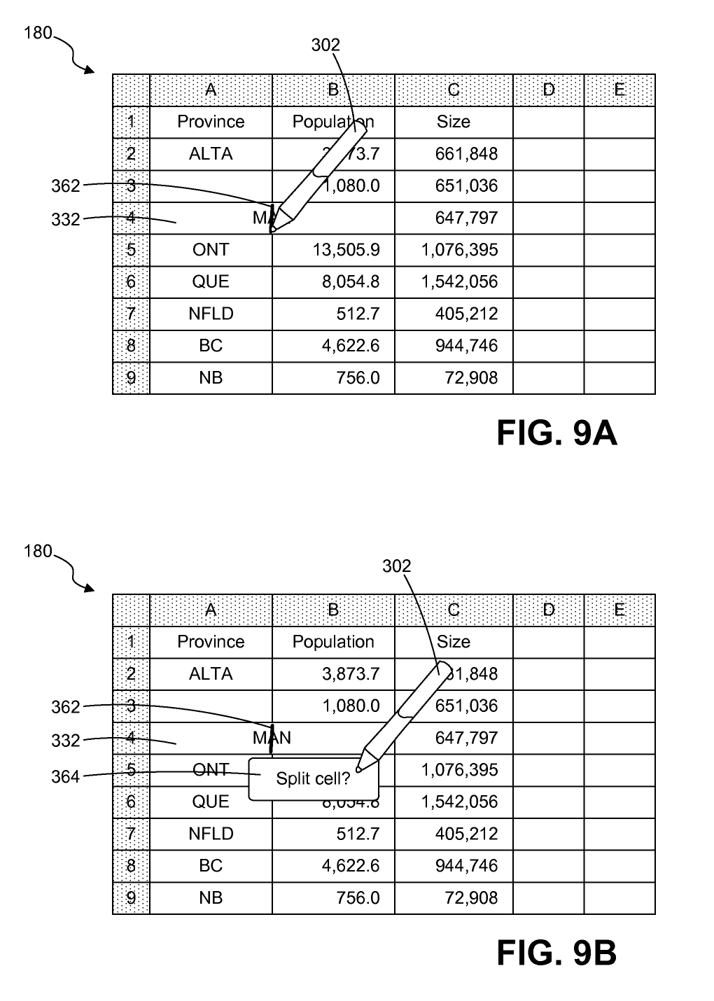

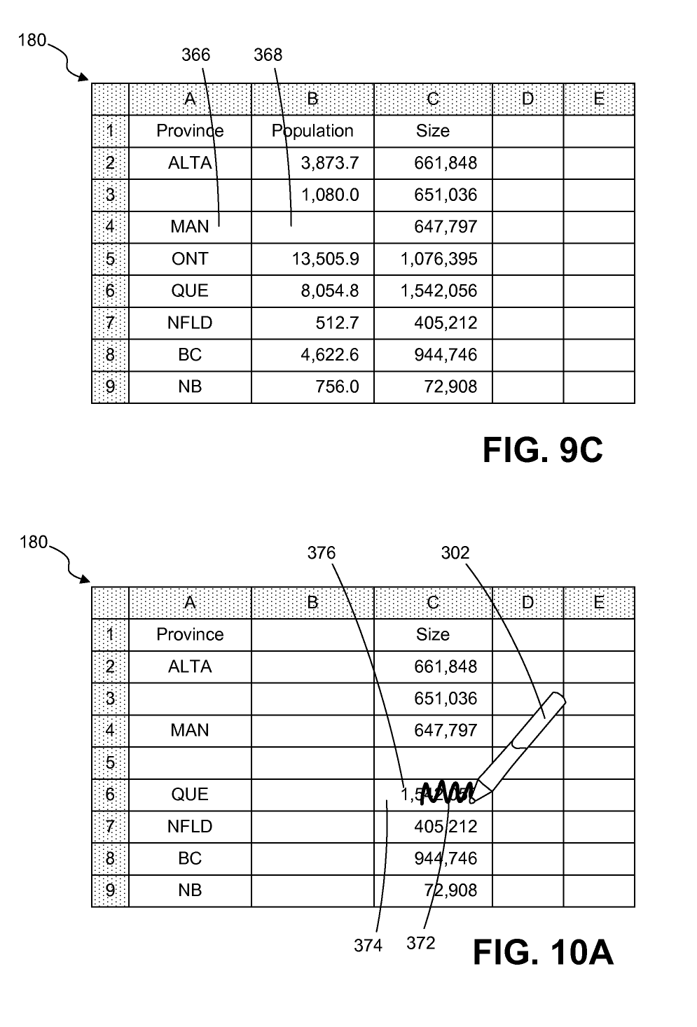

The split-cell gesture may also be used for splitting cells into cells in the same row. Referring to FIGS. 9A to 9C, another example of recognizing an ink annotation as a split-cell gesture is shown. As shown in FIG. 9A, a user (not shown) uses a pen tool 302 in the ink mode to draw a vertical ink annotation 362 having a substantially straight line in cell 332. As shown in FIG. 9B, after the ink annotation 362 is complete, the application program layer 144 recognizes the ink annotation 362 as a split-cell gesture, and presents a pop-up bubble 364 asking the user to confirm the command associated with the recognized gesture. The user confirms the split-cell gesture. As shown in FIG. 9C, the ink annotation 362 is then deleted, and the command associated with the split-cell gesture is executed. As a result, cell 332 is split to two cells 366 and 368 in the same row.

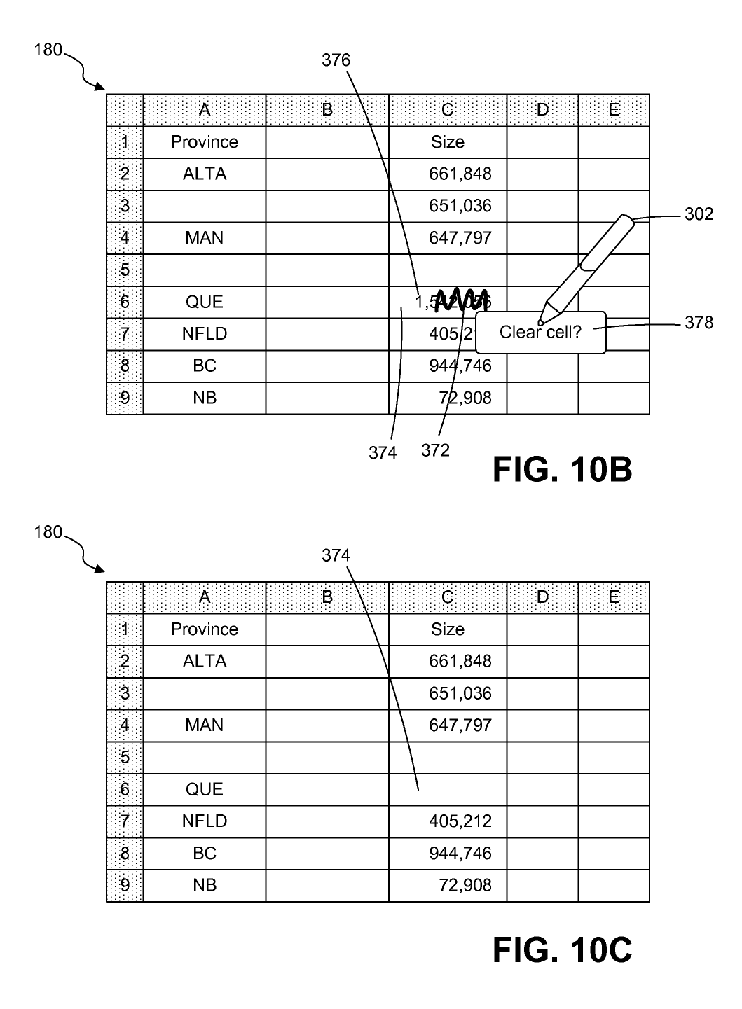

Referring to FIGS. 10A to 10C, an example of recognizing an ink annotation as a clear-cell-content gesture is shown. As shown in FIG. 10A, a user (not shown) uses a pen tool 302 in the ink mode to draw an ink annotation 372 having a zigzag shape in cell 374 having content 376. As shown in FIG. 10B, after the ink annotation 372 is complete, the application program layer 144 recognizes the ink annotation 372 as a clear-cell-content gesture, and presents a pop-up bubble 378 asking user to confirm the command associated with the recognized gesture. The user confirms the clear-cell-content gesture. As shown in FIG. 10C, the ink annotation 372 is then deleted, and the command associated with the clear-cell-content gesture is executed. As a result, the content 376 in cell 374 is deleted, and cell 374 becomes an empty cell.

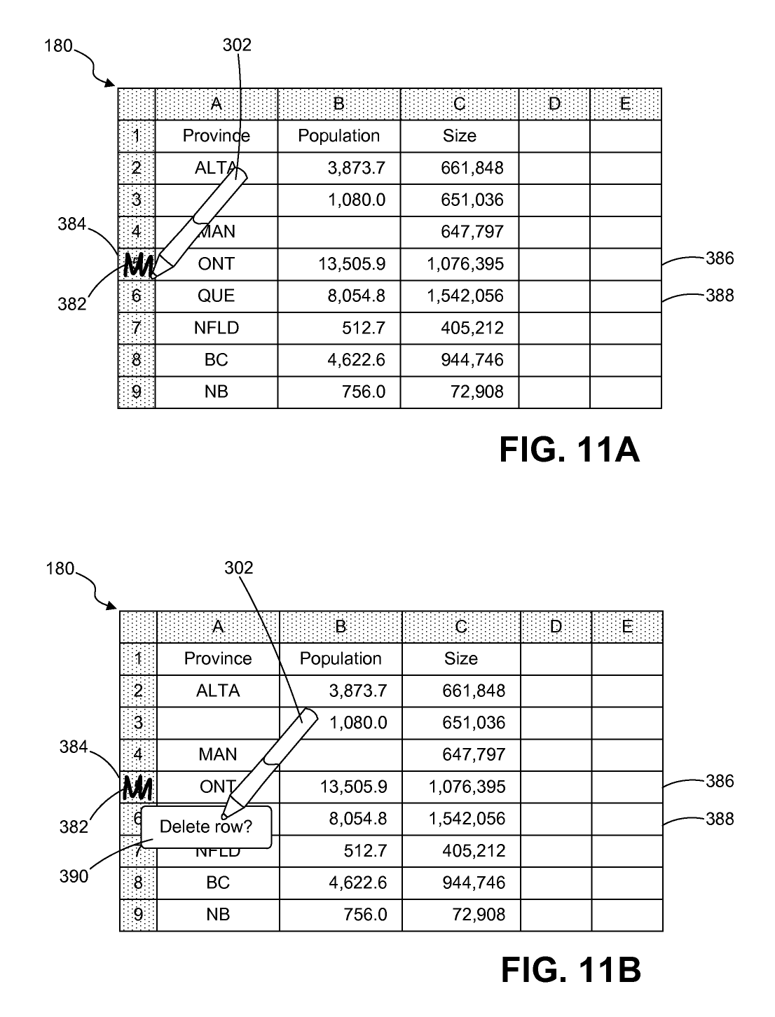

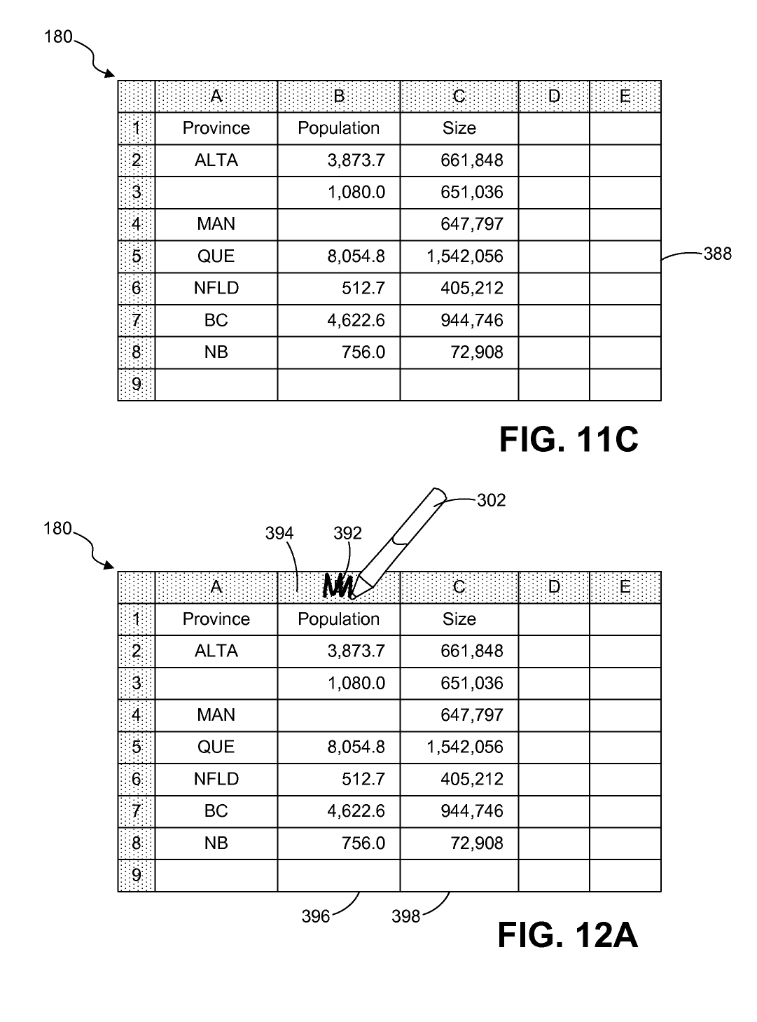

Referring to FIGS. 11A to 11C, an example of recognizing an ink annotation as a delete-row gesture is shown. As shown in FIG. 11A, a user (not shown) uses a pen tool 302 in the ink mode to draw an ink annotation 382 having a zigzag shape on the row header 384 of row 386, which is the fifth row of the spreadsheet 180. As shown in FIG. 11B, after the ink annotation 382 is complete, the application program layer 144 recognizes the ink annotation 382 as a delete-row gesture, and presents a pop-up bubble 390 asking user to confirm the command associated with the recognized gesture. The user confirms the delete-row gesture. As shown in FIG. 11C, the ink annotation 382 is deleted, and the command associated with the delete-row gesture is executed. As a result, the entire row 386 is deleted, and all rows that were previously below row 386 are shifted up such that row 388 becomes the fifth row of the spreadsheet 180, for example.

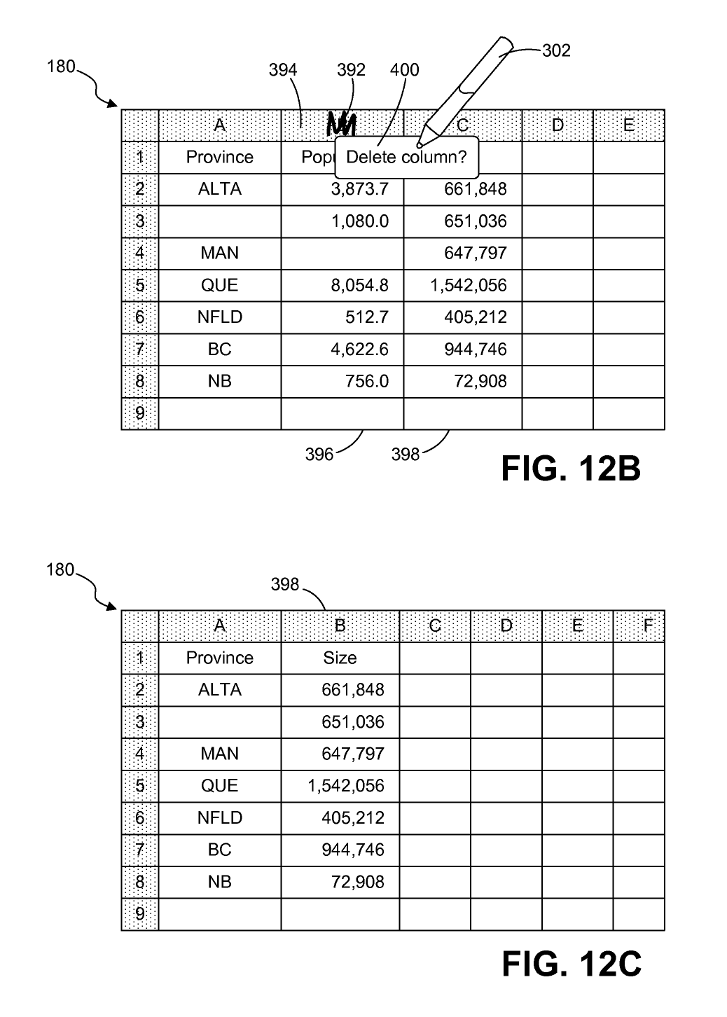

Referring to FIGS. 12A to 12C, an example of recognizing an ink annotation as a delete-column gesture is shown. As shown in FIG. 12A, a user (not shown) uses a pen tool 302 in the ink mode to draw an ink annotation 392 having a zigzag shape on the column header 394 of column 396, which is column “B” of the spreadsheet 180. As shown in FIG. 12B, after the ink annotation 392 is complete, the application program layer 144 recognizes the ink annotation 392 as a delete-column gesture, and presents a pop-up bubble 400 asking user to confirm the command associated with the recognized gesture. The user confirms the delete-column gesture. As shown in FIG. 12C, the ink annotation 392 is deleted, and the command associated with the delete-row gesture is executed. As a result, the entire column 396 is deleted, and all columns that were previously to the right of column 396 are shifted left such that row 398 becomes the column “B” of the spreadsheet 180, for example.

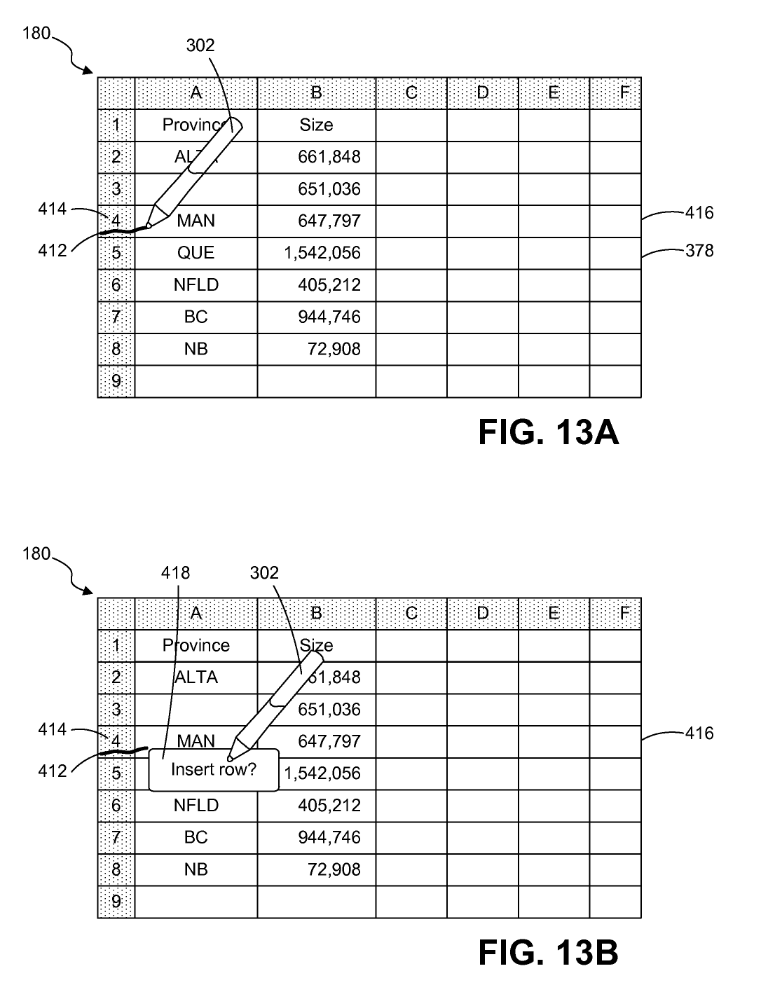

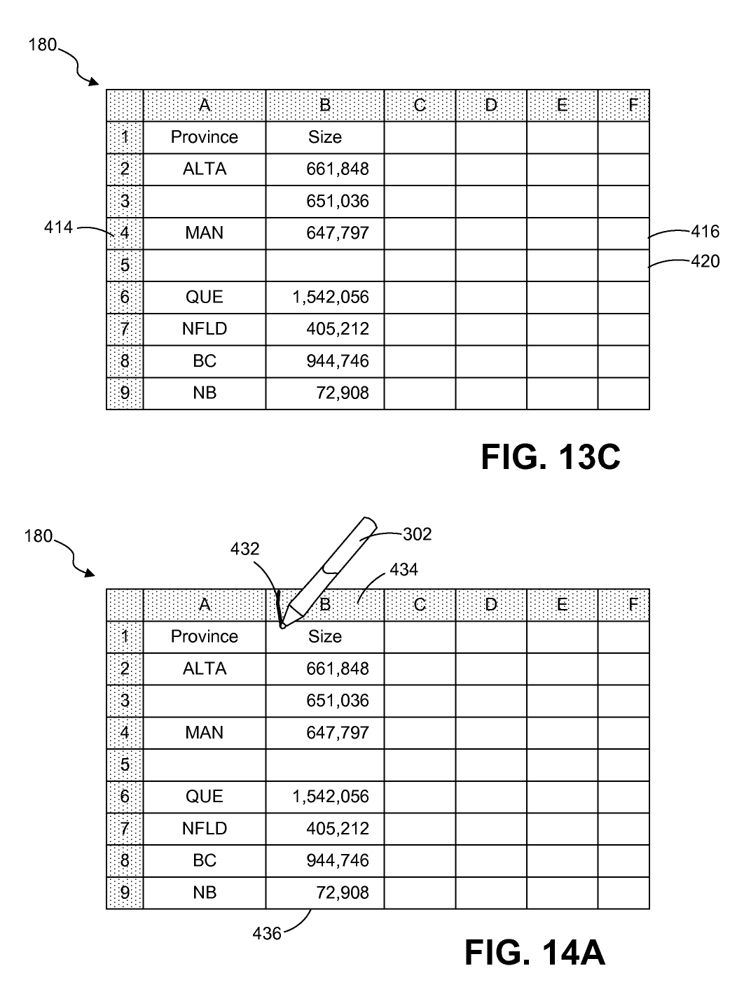

Referring to FIGS. 13A to 13C, an example of recognizing an ink annotation as an insert-row gesture is shown. As shown in FIG. 13A, a user (not shown) uses a pen tool 302 in the ink mode to draw a horizontal ink annotation 412 having a substantially straight line. The ink annotation 412 starts from the row header 414 of row 416, which is the fourth row of the spreadsheet 180, and has a length between two-thirds and three (3) times of the width of the row header 414. As shown in FIG. 13B, after the ink annotation 412 is complete, the application program layer 144 recognizes the ink annotation 412 as an insert-row gesture, and presents a pop-up bubble 418 asking the user to confirm the command associated with the recognized gesture. The user confirms the insert-row gesture. The ink annotation 412 is deleted and the command associated with the insert-row gesture is executed to insert a row to the spreadsheet 180. When inserting a row, the spreadsheet program uses the location of the ink annotation 412 on the row header 414 to determine whether a row should be inserted above or below the row 416 that the row header 414 represents. Generally, if the location of the ink annotation is on the lower half of the row header 414, a row is inserted in the spreadsheet 180 below the row 416 that the row header 414 represents. If the location of the ink annotation is on the upper half of the row header 414, a row is inserted in the spreadsheet above the row 416 that the row header 414 represents. If the ink annotation is in between two row headers, a row is inserted to the spreadsheet between the two rows that the row headers respectively represent. In this example, the ink annotation 412 is on the lower half of the row header 414. Therefore, as shown in FIG. 13C, a new row 420 is inserted in the spreadsheet 180 below row 416 that the row header 414 represents.

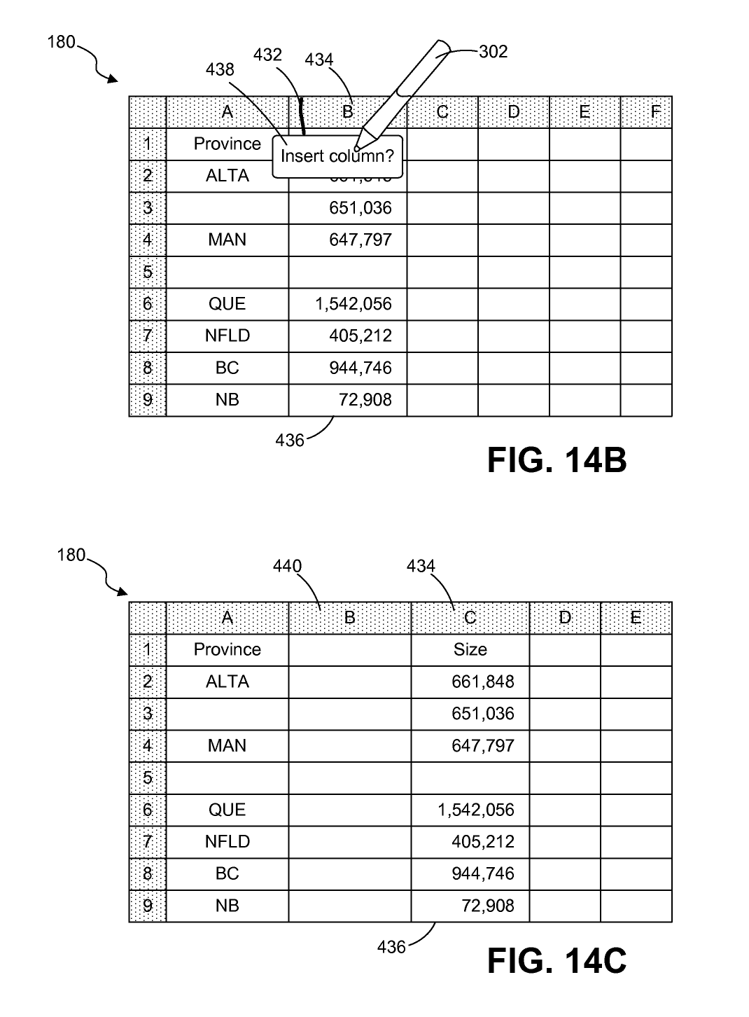

Referring to FIGS. 14A to 14C, an example of recognizing an ink annotation as an insert-column gesture is shown. As shown in FIG. 14A, a user (not shown) uses a pen tool 302 in the ink mode to draw a vertical ink annotation 432 having a substantially straight line. The ink annotation 412 starts from the column header 434 of column 436, which is column “B” of the spreadsheet 180, and has a length between two-thirds and three (3) times of the height of the column header 434. As shown in FIG. 14B, after the ink annotation 432 is complete, the application program layer 144 recognizes the ink annotation 432 as an insert-column gesture, and presents a pop-up bubble 438 asking user to confirm the command associated with the recognized gesture. The user confirms the insert-column gesture. The ink annotation 432 is deleted, and the command associated with the insert-column gesture is executed to insert a column to the spreadsheet 180. When inserting a column, the spreadsheet program uses the location of the ink annotation 432 on the column header 434 to determine whether a column should be inserted to the left or the right of the column 436 that the column header 434 represents. Generally, if the location of the ink annotation is on the left half of the column header 434, a column is inserted to the left of the column 436 that the column header 434 represents. If the location of the ink annotation is on the right half of the column header 434, a column is inserted to the right of the column 436 that the column header 434 represents. If the ink annotation is in between two column headers, a column is inserted to the spreadsheet between the two columns that the column headers respectively represent. In this example, the ink annotation 432 is on the left half of the column header 434. Therefore, as shown in FIG. 14C, a new column 440 is inserted to the left hand side of the column 436 that the row header 434 represents. The newly inserted column 440 becomes the column “B” and the remaining columns are re-labeled accordingly.

In above examples, the row headers and column headers are automatically defined and assigned to the table by the application program. However, in some alternative embodiments, the application program allows user to designate row headers and/or column headers.

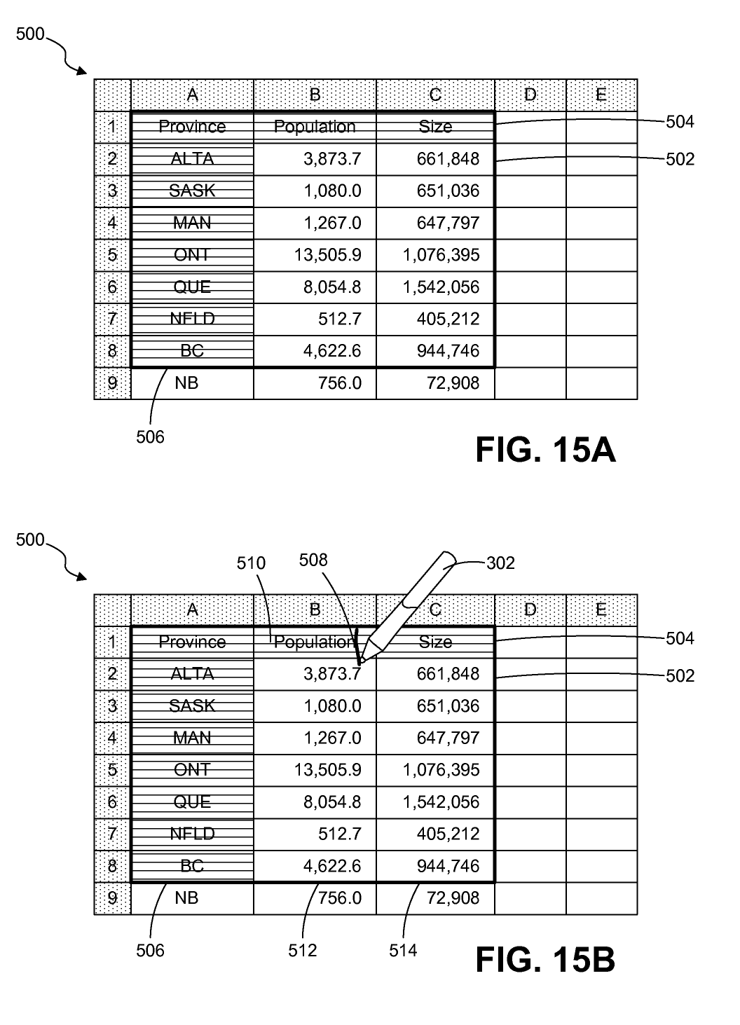

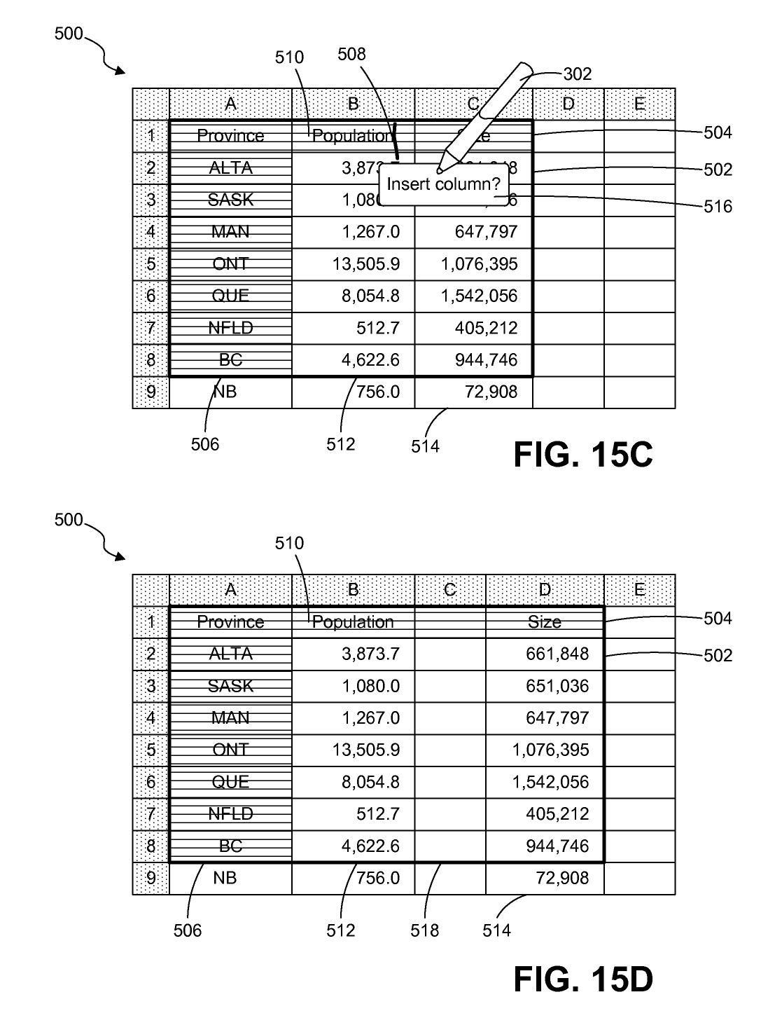

Referring to FIGS. 15A to 15D, an example of recognizing an ink annotation as an insert-column gesture in a spreadsheet having custom row headers and column headers is shown. As shown in FIG. 15A, the spreadsheet program allows user to designate a subset of cells in the spreadsheet as a user-customized table, and designate the one or more rows of the user-customized table as the column headers and/or one or more columns of the user-customized table as the row headers. In this example, the user has designated a subset of cells 502 as a user-customized table. The top row 504 of the user-customized table 502 has been designated as the column header. The leftmost column 506 of the user-customized table 502 has been designated as the row header.

As shown in FIG. 15B, a user (not shown) uses a pen tool 302 in the ink mode to draw a vertical ink annotation 508 having a substantially straight line. The ink annotation 508 starts from the column header 510 of column 512 and has a length between two-thirds and three (3) times the height of the column header 510. As shown in FIG. 15C, after the ink annotation 508 is complete, the application program layer 144 recognizes the ink annotation 508 as an insert-column gesture and presents a pop-up bubble 516 asking the user to confirm the command associated with the recognized gesture. The user confirms the insert-column gesture. The ink annotation 508 is deleted and the command associated with the insert-column gesture is executed to insert a column to the spreadsheet 500. As the ink annotation 508 is located on the right half of the column header 510, a new column is inserted to the right of the column 512. Previously existent columns, such as Column C, are shifted to the right to accommodate the new column. FIG. 15D shows the user-customized table 502 after a new column 518 is inserted therein between columns 512 and 514. The size of the user-customized table 502 is enlarged because the user-customized table 502 now comprises more columns.

Similar to the embodiment with automatically assigned row headers and column headers, in this embodiment the application program layer 144 recognizes cell gestures and executes cell manipulation commands associated therewith. For example, a user may draw a zigzag shaped ink annotation in a cell that is not a row header or a column-header. The application program recognizes the ink annotation as a clear-cell-content gesture. After user confirmation, the application program layer 144 executes the command associated with the recognized gesture. As a result, the content of the cell is deleted and the cell becomes an empty cell.

In this embodiment, a row or column gesture is recognized if, while satisfying other gesture criteria, the ink annotation starts from a user-designated row header or user-designated column header, respectively. When the command associated with the row or column gesture is executed, the command applies to the corresponding target row or column of the spreadsheet. Therefore, cells outside the user-customized table 502 may also be affected. In an alternative embodiment, the command associated with the row or column gesture, when executed, is only applied to the target row or column of the user-customized table such that cells outside the user-customized table 502 would not be affected.

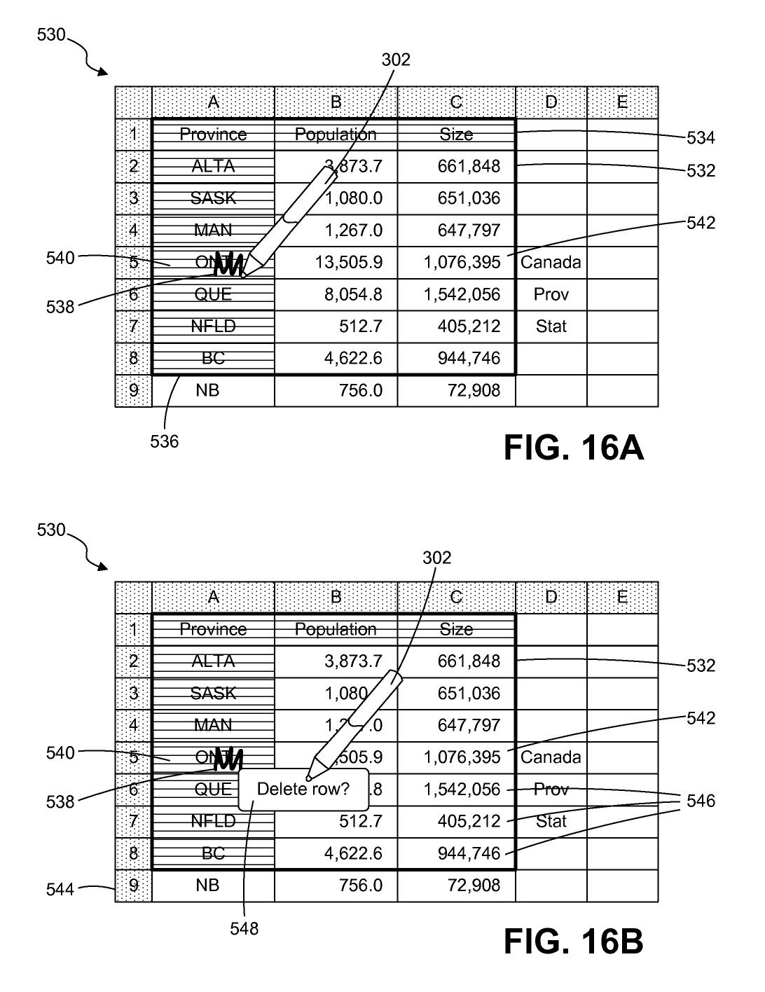

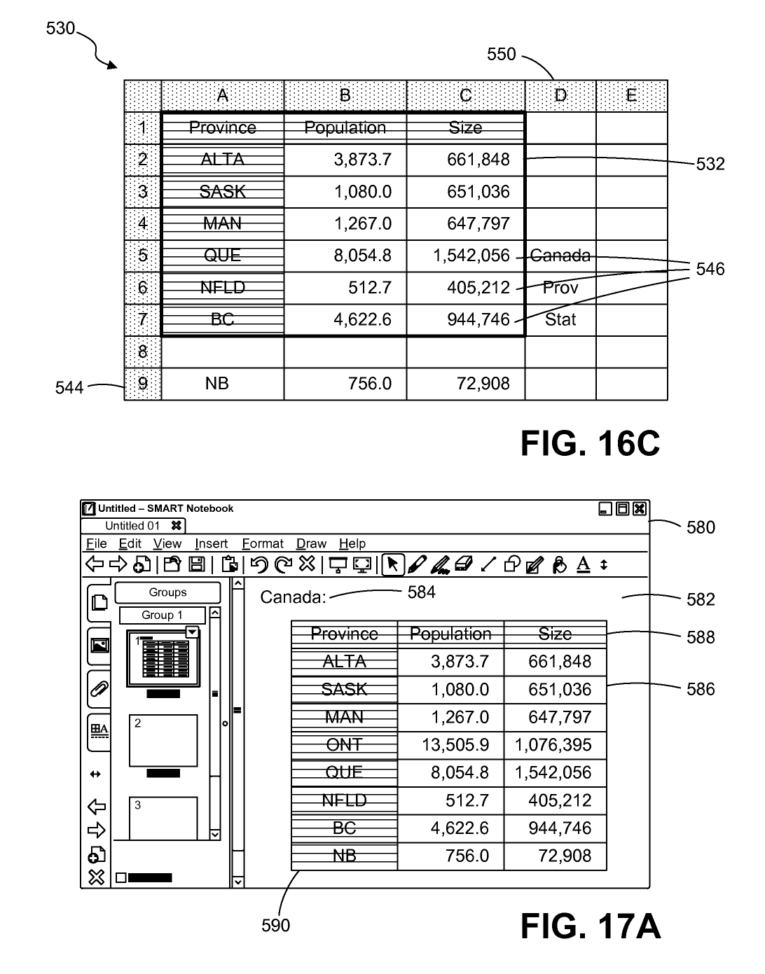

Referring to FIGS. 16A to 16C, an example of a delete-row gesture that is applied to only affects cells in a user customized table is shown. FIG. 16A shows a portion of a spreadsheet 530. As shown, a user (not shown) has designated a subset of cells 532 as a user-customized table, and has designated the top row 534 of the user-customized table 532 as the column header and the leftmost column 536 of the user-customized table 532 as the row header. The user uses a pen tool 302 in the ink mode to draw an ink annotation 538 having a zigzag shape on the user-designated row header 540 of row 542.

As shown in FIG. 16B, after the ink annotation 538 is complete, the application program layer 144 recognizes the ink annotation 538 as a delete-row gesture, and presents a pop-up bubble 548 asking the user to confirm the command associated with the recognized gesture. The user confirms the delete-row gesture. The ink annotation 538 is deleted, and the command associated with the delete-row gesture is executed.

As shown in FIG. 16C, the entire row 542 of the user-customized table 532 is deleted, and the rows 546 originally below row 542 are moved up. The size of the user-customized table 532 is shrunken, as the user-customized table 532 now comprises fewer rows. As can be seen, however, deleting row 542 of the user-customized table 532 does not affect cells outside the user-customized table 532. For example, the ninth row 544 of the spreadsheet 530 is outside of the user-customized table 532 and is not moved up while rows 546 of the user-customized table 532 are moved up. Similarly, cells in column 550, column “D”, of the spreadsheet 530 are outside of the user-customized table 532 and are likewise not affected by the deletion of row 542.

Similar to the embodiment that affects all rows and columns in the spreadsheet, in this embodiment the application program layer 144 recognizes cell gestures and executes cell manipulation commands associated therewith. For example, a user may draw a zigzag shaped ink annotation in a cell that is not a row header or column header. The application program layer 144 recognizes the ink annotation as a clear-cell-content gesture. After user confirmation, the application program layer 144 executes the command associated with the recognized gesture. As a result, the content of the cell is then deleted and the cell becomes an empty cell.

Those skilled in the art will appreciate that the subject invention is not limited to the manipulation of tables in the form of spreadsheet. In alternative embodiments, the subject invention may also be used for manipulating tables in other forms.

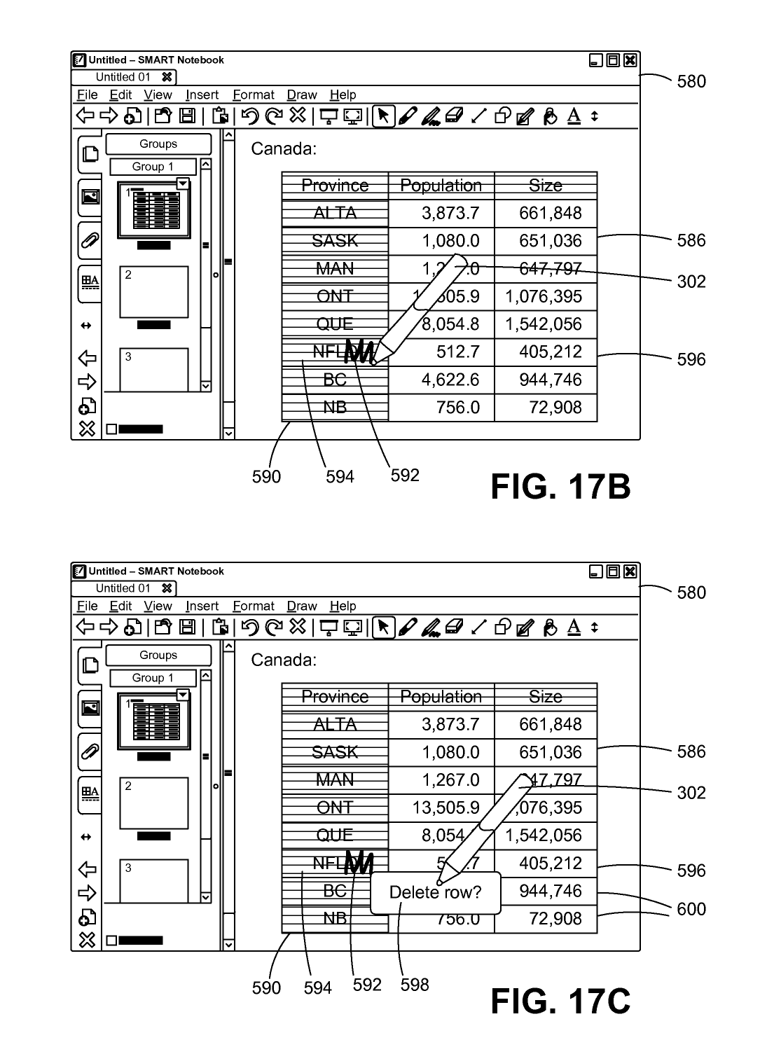

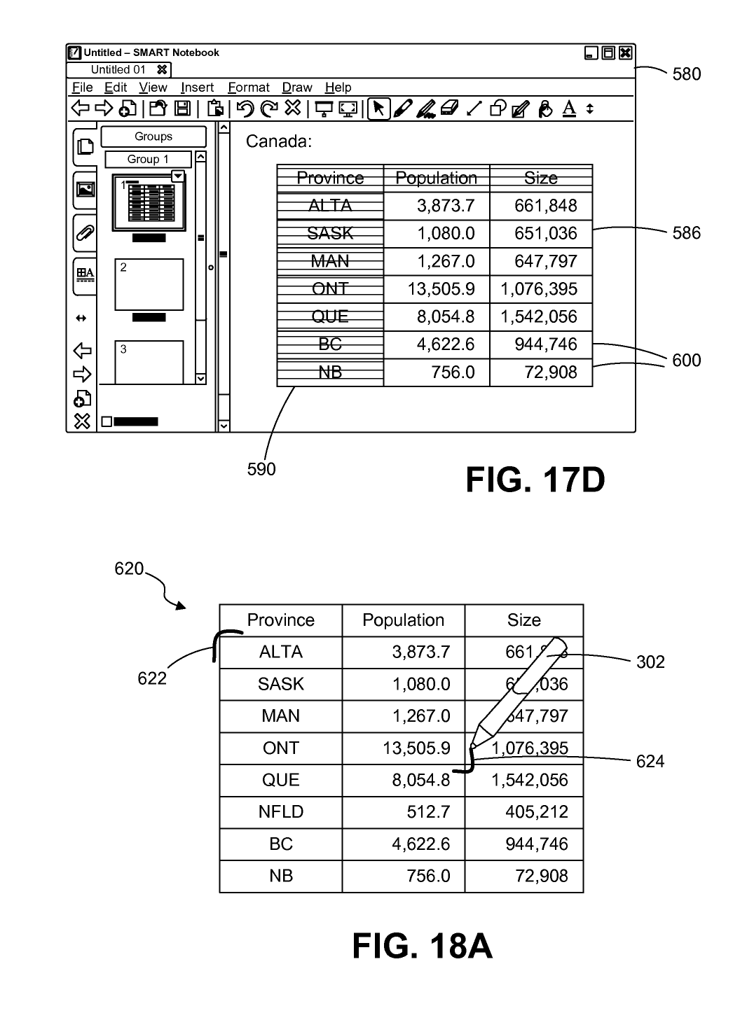

Referring to FIGS. 17A to 17D an example of manipulating tables in the form of a table object in a SMART Notebook™ file is shown. FIG. 17A shows a SMART Notebook™ file created in SMART Notebook™ application program offered by SMART Technologies ULC of Calgary, Alberta, Canada. As shown, the window 580 of the SMART Notebook™ application program comprises a canvas 582 showing a page of the SMART Notebook™ file. In this example, the page of the SMART Notebook™ file comprises a text object 584 and a table object 586. A user (not shown) has designated the top row 588 of the table object 586 as column headers, and the leftmost column 590 as row headers.

As shown in FIG. 17B, the user uses a pen tool 302 in the ink mode to draw an ink annotation 592 having a zigzag shape on the user-designated row header 594 of row 596. As shown in FIG. 17C, after the ink annotation 592 is complete, the SMART Notebook™ application program recognizes the ink annotation 592 as a delete-row gesture, and presents a pop-up bubble 598 asking the user to confirm the command associated with the recognized gesture. The user confirms the delete-row gesture. The ink annotation 592 is deleted, and the command associated with the delete-row gesture is executed. As shown in FIG. 17D, the entire row 596 of the table object 586 is deleted, and the rows 600 originally below row 596 are moved up. The size of the table object 586 is shrunken, as the table object 586 comprises fewer rows.

Similar to the embodiments described with reference to a spreadsheet application, in this embodiment the application program layer 144 recognizes cell gestures and executes cell manipulation commands associated therewith. For example, a user may draw a zigzag shaped ink annotation in a cell that is not a row header or column header. The application program recognizes the ink annotation as a clear-cell-content gesture. After user confirmation, the application program executes the command associated with the recognized gesture. As a result, the content of the cell is then deleted and the cell becomes an empty cell.

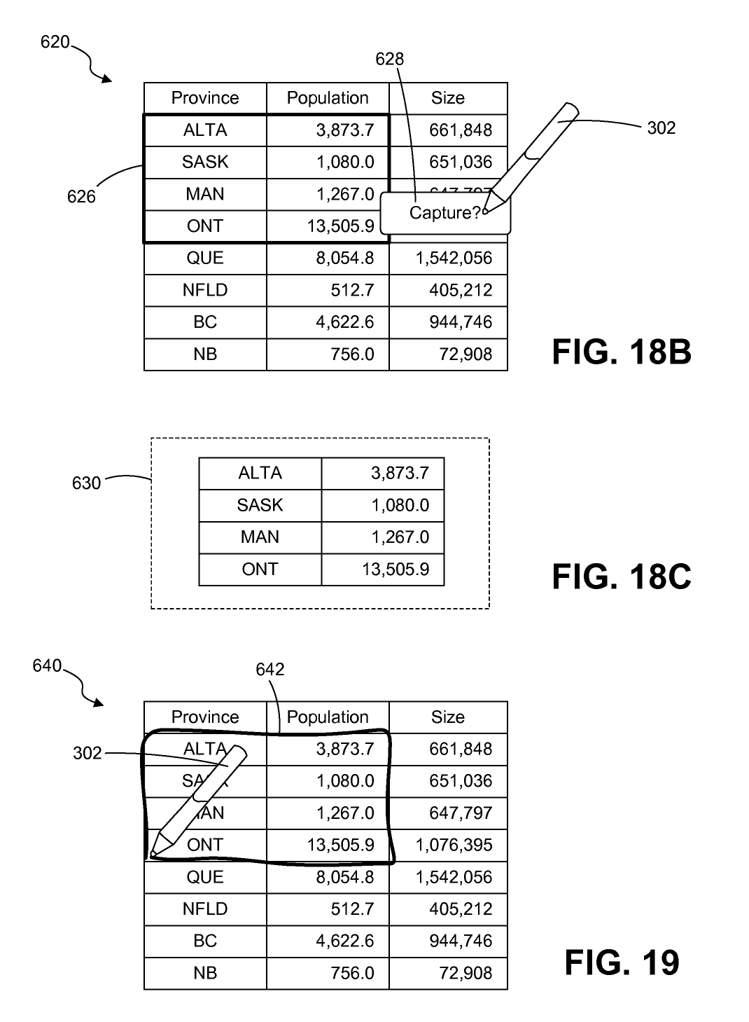

Although certain ink gestures are described above, other ink gestures may also be made available to the user. For example, referring to FIGS. 18A to 18C, an example of capturing a portion of table using an ink gesture is shown. As shown in FIG. 18A, a table 620 is displayed on the GUI of an application program (not shown). A user (not shown) uses a pen tool 302 in the ink mode to draw a first and a second ink annotations 622 and 624 to designate opposite corners of a selection rectangle that selects the cells to be captured. The application program layer 144 recognizes the ink annotation pair 622 and 624 as a capture-cell gesture, and determines the selection rectangle defined by the ink annotation pair 622 and 624. As shown in FIG. 18B, the application program deletes the ink annotation pair 622 and 624, and displays the selection rectangle 626 to indicate the cells of table 620 to be selected. Then, the application program pops up a bubble 628 asking user to confirm the command associated with the recognized gesture. As shown in FIG. 18C, after the user has confirmed the capture-cell gesture, the cells enclosed by the selection rectangle 626 are copied to the system clipboard 630.

Referring to FIG. 19, in an alternative embodiment the capture-cell gesture is defined as an ink annotation substantially in a rectangular shape. A user (not shown) may use a pen tool 302 in the ink mode to draw a substantially rectangular-shaped ink annotation 642 enclosing the cells of a table 640 to be captured. The application program recognizes the capture-cell gesture and determines the selection rectangle. Following steps similar to those shown in FIGS. 18B to 18C, after the user confirms the capture-cell gesture, the cells selected by the selection rectangle are copied to the system clipboard.

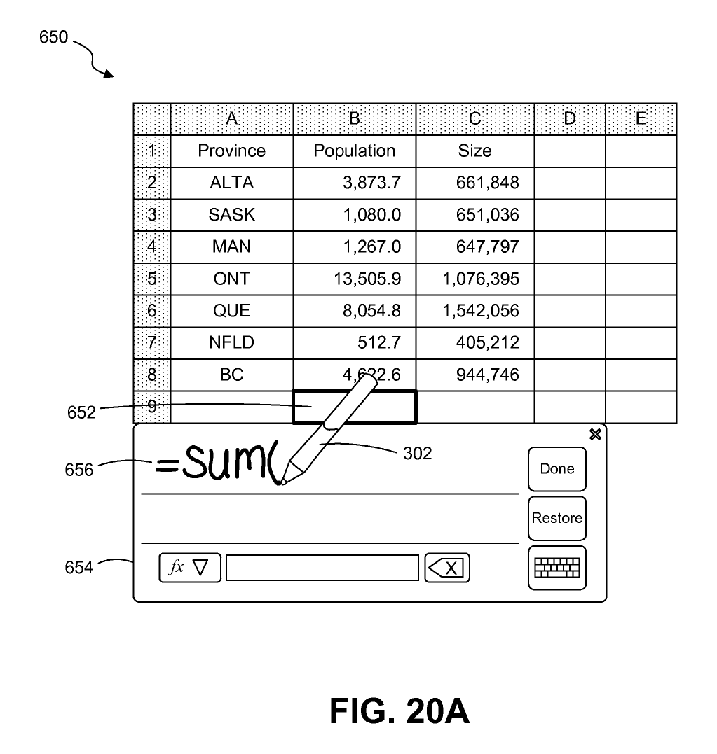

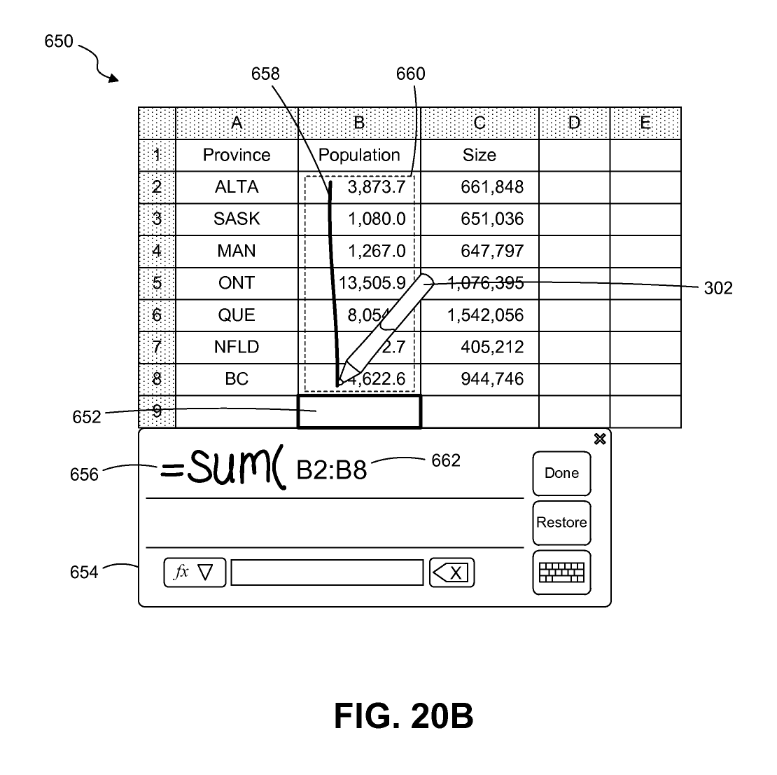

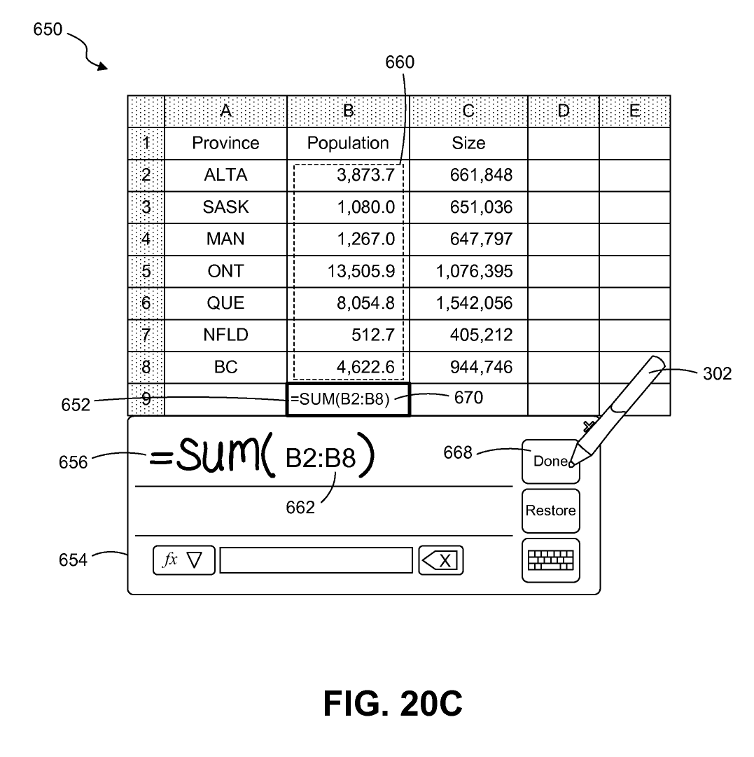

In yet another embodiment, the application program layer 144 further distinguishes different ink gestures in similar ink annotation shapes based on the state of the application program at the time the ink annotation is drawn. For example, referring to FIGS. 20A to 20C, an example of recognizing an ink annotation as a define-cell-range gesture is shown.

As shown in FIG. 20A, a user (not shown) has selected a cell 652 of a table (a spreadsheet in this example) 650 and launched a formula-input dialog 654 for inputting a formula into the selected cell 652. The formula-input dialog 654 allows user to inject ink annotation therein, and recognizes injected ink into a formula. In the example shown in FIG. 20A, the user has written ink annotations 656 that will be recognized as a string “=SUM(” representing a summation function to be used in the formula. The user needs to specify a range of cells as the parameter for the summation function.

As shown in FIG. 20B, the user uses the pen tool 302 to draw an ink annotation 658 substantially in a straight line over a range of cells 660. After the ink annotation 658 is complete, the application program layer 144 analyses the ink annotation 658 to determine if it represents an ink gesture. In this embodiment, an ink annotation having substantially a straight line, starting from a non-header cell (a cell that is not a row or column header) and traversing two or more cells may be recognized as a merge-cell gesture or a define-cell-range gesture based on the state of the application program. If the application program is at the formula-input state (that is, when the formula-input dialog 654 is displayed), the ink annotation is recognized as a define-cell-range gesture. However, if the application program is not at the formula-input state, the ink annotation is recognized as a merge-cell gesture.

In the example shown in FIG. 20B, the formula-input dialog 654 is displayed and the application program is at the formula-input state. Therefore, the application program layer 144 recognizes the ink annotation 658 as a define-cell-range gesture. The range of cells 660 that the ink annotation 658 traverses are determined and specified as a range 662 in the formula-input dialog 654.

As shown in FIG. 20C, the user uses the pen tool 302 to finish the formula 656, and taps the “Done” button 668. The application program layer 144 then recognizes the ink annotation in the formula 656, combining with the user-designated range 662, and enters the completed formula 670 into cell 652.

Accordingly, it will be appreciated that the application program layer 144 is configured to process input events received from the input interface 142 to recognize ink annotation input by a pointer as ink gestures. If the ink annotation is completed within the predefined brief time period T₂, then it is further analysed. Specifically, the ink annotation is categorized based on a location at which the ink annotation began. The ink annotation is then compared with category-specific criteria to determine if it qualifies as an ink gesture. If the ink annotation is determined to be an ink gesture, a pop-up bubble is presented to a user to confirm that the ink annotation has been correctly interpreted. Upon confirmation of the ink gesture, a corresponding command, or commands, is executed to implement the ink gesture and the ink annotation is deleted.

The application program layer 144 and corresponding application programs may comprise program modules including routines, object components, data structures, and the like, and may be embodied as computer readable program code stored on a non-transitory computer readable medium. The computer readable medium is any data storage device that can store data. Examples of computer readable media include for example read-only memory, random-access memory, CD-ROMs, magnetic tape, USB keys, flash drives and optical data storage devices. The computer readable program code may also be distributed over a network including coupled computer systems so that the computer readable program code is stored and executed in a distributed fashion.

Although in embodiments described above, the IWB is described as comprising machine vision to register pointer input, those skilled in the art will appreciate that other interactive boards employing other machine vision configurations, analog resistive, electromagnetic, capacitive, acoustic or other technologies to register input may be employed.

For example, products and touch systems may be employed such as for example: LCD screens with camera based touch detection (for example SMART Board™ Interactive Display—model 8070i); projector based IWB employing analog resistive detection (for example SMART Board™ IWB Model 640); projector based IWB employing a surface acoustic wave (WAV); projector based IWB employing capacitive touch detection; projector based IWB employing camera based detection (for example SMART Board™ model SBX885ix); table (for example SMART Table™—such as that described in U.S. Patent Application Publication No. 2011/069019 assigned to SMART Technologies ULC of Calgary, the entire disclosures of which are incorporated herein by reference); slate computers (for example SMART Slate™ Wireless Slate Model WS200); podium-like products (for example SMART Podium™ Interactive Pen Display) adapted to detect passive touch (for example fingers, pointer, etc,—in addition to or instead of active pens); all of which are provided by SMART Technologies ULC of Calgary, Alberta, Canada.

Those skilled in the art will appreciate that, in some alternative embodiments, the interactive input system does not comprise an IWB. Rather, it may comprise a touch-sensitive monitor. The touch-sensitive monitor may be a device separate from the computing device, or alternatively be integrated with the computing device, e.g., an all-in-one computer. In some other embodiments, the interactive input system may be a mobile device having an integrated touch-sensitive display, e.g., a smart phone, a tablet, a PDA or the like.

Although in embodiments described above, user may apply gestures using a pointer in the ink mode, those skilled in the art will appreciate that in some alternative embodiments, user may alternatively apply gesture using a pointer in the cursor mode.

Although embodiments have been described above with reference to the accompanying drawings, those of skill in the art will appreciate that variations and modifications may be made without departing from the scope thereof as defined by the appended claims.

What is claimed is:

1. A computerized method for manipulating a table comprising a plurality of cells, at least one row header and at least one column header, the method comprising:
receiving input events representing a pointer contacting an interactive surface;
displaying an ink annotation on the interactive surface in response to the input events;
determining that the ink annotation corresponds with an ink gesture by comparing the ink annotation with a plurality of predefined ink gestures; and
deleting the ink annotation and executing one or more commands associated with the ink gesture.

2. The method of claim 1, wherein comparing the ink annotation with a plurality of predefined ink gestures comprises categorizing the ink annotation based on a location at which the ink annotation began, comparing the categorized ink annotation with category-specific criteria, and associating the ink annotation with a corresponding one of the plurality of predefined ink gestures based on the comparison.

3. The method of claim 1, wherein determining whether the ink annotation corresponds with an ink gesture is performed only if the ink annotation was completed within a predefined brief time period.

4. The method of claim 1, further comprising displaying a message on the interactive surface requesting confirmation that the ink gesture associated with the annotation is correct.

5. The method of claim 4, wherein the message is displayed as a pop-up bubble.

6. The method of claim 2, wherein the ink annotation is categorized as one of a gesture impacting a row of the table, a gesture impacting a column of the table, or a gesture impacting one or more cells of the table.

7. The method of claim 1 wherein the row header and the column header are automatically defined by an application program processing the table.

8. The method of claim 1 wherein the row header and the column header are defined by a user.

9. The method of claim 1, wherein the table is a spreadsheet.

10. The method of claim 1, wherein the table is a portion of a spreadsheet

11. The method of claim 10, wherein the executed one or more commands only impacts cells in the table.

12. The method of claim 1, wherein the table is a table object in a word processing document.

13. The method of claim 1, wherein the table is a table object in a presentation file.

14. A system configured to manipulating a table comprising a plurality of cells, at least one row header and at least one column header, the system comprising:
an interactive display configured to display content and receive user input;
a computer having memory for storing instructions, which when executed by a processor cause the computer to:
receive input events representing a pointer contacting an interactive surface;
display an ink annotation on the interactive surface in response to the input events;
determine that the ink annotation corresponds with an ink gesture by comparing the ink annotation with a plurality of predefined ink gestures; and
delete the ink annotation and executing one or more commands associated with the ink gesture.

15. The system of claim 14, wherein comparing the ink annotation with a plurality of predefined ink gestures comprises categorizing the ink annotation based on a location at which the ink annotation began, comparing the categorized ink annotation with category-specific criteria, and associating the ink annotation with a corresponding one of the plurality of predefined ink gestures based on the comparison.

16. The system of claim 14, wherein the instructions only cause the processor to determine whether the ink annotation corresponds with an ink gesture is performed only if the ink annotation was completed within a predefined brief time period.

17. The system of claim 14, further comprising instruction to display a message on the interactive surface requesting confirmation that the ink gesture associated with the annotation is correct.

18. The system of claim 15, wherein the ink annotation is categorized as one of a gesture impacting a row of the table, a gesture impacting a column of the table, or a gesture impacting one or more cells of the table.

19. The method of claim 14, wherein the table is a portion of a spreadsheet and the executed one or more commands only impacts cells in the table.

20. A computer readable medium having stored thereon instructions for manipulating a table comprising a plurality of cells, at least one row header and at least one column header, the instructions, when executed by a processor, cause the processor to implement:
receiving input events representing a pointer contacting an interactive surface;
displaying an ink annotation on the interactive surface in response to the input events;
determining that the ink annotation corresponds with an ink gesture by comparing the ink annotation with a plurality of predefined ink gestures; and
deleting the ink annotation and executing one or more commands associated with the ink gesture.

21. The computer readable medium of claim 20, wherein comparing the ink annotation with a plurality of predefined ink gestures comprises categorizing the ink annotation based on a location at which the ink annotation began, comparing the categorized ink annotation with category-specific criteria, and associating the ink annotation with a corresponding one of the plurality of predefined ink gestures based on the comparison.
